(19) United States
(12) Patent Application Publication
(10) Pub. No.: US 2026/0217884 A1
(43) Pub. Date: Jul. 30, 2026

(54) FORMULATION AND METHOD FOR COMPATIBILIZING POST-CONSUMER RECYCLED PLASTICS USING RANDOM COPOLYMERS

(71) Applicant: Nano and Advanced Materials Institute Limited, Hong Kong (HK)

(72) Inventors: Lisi HE, Hong Kong (HK); Ya HUANG, Hong Kong (HK); Shuyuan ZHANG, Hong Kong (HK); Jianli WANG, Hong Kong (HK); Man Kit CHAN, Hong Kong (HK); Sean Seang LEE, Hong Kong (HK)

(21) Appl. No.: 19/436,738

(22) Filed: Dec. 30, 2025

Related U.S. Application Data
(60) Provisional application No. 63/749,865, filed on Jan. 27, 2025.

(51) Int. Cl. C08F 210/16; C08J 11/06

(52) U.S. Cl. CPC C08F 210/16; C08J 11/06; C08J 2323/06; C08J 2323/12; C08J 2325/06; C08J 2367/03; C08J 2369/00

(57) ABSTRACT

The present disclosure relates to a formulation (100) and a method (200) for compatibilizing post-consumer recycled plastics. The formulation (100) also comprises a random copolymer represented by the structural formula (A)n(B)m(C)p(D)q. The n, m, p, and q are independently no less than 1, The A, B, C, and D are structurally different and arranged in a random sequence. The formulation (100) comprises a plurality of additive a plurality of fillers and a combination thereof. The formulation (100) ensures universal compatibility with mixed post-consumer recycled plastics, reduces quality variations, enhances process stability, and improves mechanical properties, requiring a dosage of a pre-determined amount for efficient and sustainable recycling applications.

### CROSS REFERENCE TO RELATED APPLICATIONS

This application claims priority of U.S. Provisional Application No. 63/749,865 filed on Jan. 27, 2025 under 35 U.S.C. § 119(e), the entire contents of all of which are hereby incorporated by reference.

### FIELD OF THE INVENTION

Embodiments of the present invention relate to the field of polymer science and plastic recycling, and specifically relates to a formulation and method for compatibilizing post-consumer recycled plastics using random copolymers.

### Description of the Related Art

This invention offers a single solution for recycling mixed plastic waste, regardless of the type of contaminants. It can reduce the categories for extensive sorting and analysis of waste materials, making it easier, less time-consuming, and more cost-effective to recycle plastics in real-world scenarios. By addressing the complexities of mixed waste, it simplifies the recycling process, which is particularly beneficial in regions with less-developed recycling systems.

The invention enhances the stability and consistency of recycled plastic products. It reduces issues like quality variation, ensuring that recycled plastics meet the standards required for various applications. This results in more reliable and durable recycled plastic products that can replace virgin plastics in diverse industries, supporting sustainable manufacturing practices.

By enabling more effective recycling of post-consumer plastics, this invention reduces the amount of plastic waste ending up in landfills and oceans. It promotes the use of recycled materials in new products, thereby decreasing the reliance on virgin plastics and contributing to lower carbon emissions and a more sustainable plastic lifecycle.

This invention lowers operational costs for recyclers by reducing the need for precise sorting and compatibility testing of waste plastics. Its universal application minimizes the time and effort spent on extensive sorting and analysis, and allows recyclers to process a wider range of materials more efficiently.

This invention provides recyclers with more predictable and stable processing conditions. By improving compatibility among mixed plastics, it ensures smooth operations during recycling processes like extrusion or injection molding. This stability not only saves energy and time but also results in higher yields and reduced production waste.

Existing inventions are often designed to work with specific types of plastics or blends, making them unsuitable for mixed and contaminated plastic waste. This narrow focus results in limited applicability, forcing recyclers to sort waste extensively before processing, which increases time, cost, and labor.

Many current solutions require a large quantity of additives to achieve effective recycling. This high dosage not only increases the cost of recycling but also reduces the overall percentage of recycled material in the final product, making the process less sustainable and less attractive for industrial use.

Existing inventions often fail to address the unpredictability of mixed plastic waste from domestic recycling systems. This can lead to instability in the recycling process, such as uneven product quality, frequent machinery issues, and higher rates of rejected batches, all of which undermine the efficiency and profitability of recycling operations.

Many current inventions are not designed for real-world scenarios where waste plastic streams contain unknown contaminants or inorganic fillers. These solutions often require precise identification of materials, making them impractical for poorly regulated or complex recycling systems in many regions.

In conclusion, this invention provides a universal and efficient solution for recycling post-consumer plastics, addressing the limitations of existing methods. By simplifying processes, enhancing product quality, and reducing environmental impact, it transforms the recycling landscape, making sustainable practices more accessible, cost-effective, and adaptable to real-world challenges in plastic waste management.

Thus, there is a need of a formulation and method for compatibilizing post-consumer recycled plastics using random copolymers.

Therefore, the present invention provides a formulation and method for compatibilizing post-consumer recycled plastics using random copolymers.

### SUMMARY OF THE INVENTION

Embodiments of the present invention relate to a formulation for compatibilizing post-consumer recycled plastics. The formulation comprising a random copolymer represented by the structural formula (A)n(B)m(C)p(D)q. The n, m, p, and q are independently no less than 1, and wherein A, B, C, and D, are structurally different and arranged in a random sequence. The formulation ensures universal compatibility with mixed post-consumer recycled plastics, reduces quality variations, enhances process stability, and improves mechanical properties, requiring a dosage of a pre-determined amount for efficient and sustainable recycling applications.

In accordance with an embodiment of the present invention, the formulation comprises a plurality of additives, a plurality of fillers and a combination thereof.

In accordance with an embodiment of the present invention, the random copolymers may be formed using a precursor material having one or more segments selected from A, B, C, and D, and containing reactive functional groups for further radical polymerization to achieve random copolymer (A)n(B)m(C)p(D)q. The random copolymer comprises a soft and non-polar segment A, in a pre-determined amount, to enhance compatibility with low-density polyethylene (LDPE) and linear low-density polyethylene (LLDPE). The random copolymer comprises a segment B with middle rigidity, in a pre-determined amount, to provide structural adaptation to high-density polyethylene (HDPE) and polypropylene (PP). The random copolymer comprises a hard segment C, in a pre-determined amount, to reinforce compatibility with rigid plastics, including polystyrene (PS), polycarbonate (PC), and polyethylene terephthalate (PET). The random copolymer comprises a polar and reactive segment D, in a pre-determined amount, to improve compatibility with polar plastics such as polyethylene terephthalate (PET), polycarbonate (PC), and inorganic fillers, including calcium carbonate (CaCO₃).

In accordance with an embodiment of the present invention, the soft and non-polar segment A in the random copolymer comprises hydrocarbon chains with main chain lengths from C4-C10, selected from butadiene, isoprene, pentene, hexene, octene, decene, hexyl acrylate and octyl acrylate.

In accordance with an embodiment of the present invention, the segment B with middle rigidity in the random copolymer includes hydrocarbon chains with main chain lengths from C2-C4, selected from ethylene, propylene, butadiene, isoprene.

In accordance with an embodiment of the present invention, the hard segment C in the random copolymer includes aromatic groups selected from styrene, vinyl naphthalene, norbornene.

In accordance with an embodiment of the present invention, the polar and reactive segment D in the random copolymer includes polar reactive groups selected from maleic anhydride, methyl acrylate, glycidyl methacrylate, 2-acetoxyethyl methacrylate, and acrylic acid.

In accordance with an embodiment of the present invention, the simplified versions of the random copolymer compatibilizer are selected from (A)n(B)m(C)p, (A)n(B)m(D)q, and (A)n(C)p(D)q for applications involving less contaminated post-consumer recycled plastics.

In accordance with an embodiment of the present invention, the random copolymer exhibits thermal stability with a glass transition temperature (Tg) of no more than 200° C. and a decomposition temperature (Td) of no less than 300° C.

In accordance with an embodiment of the present invention, the precursor material for the preparation of the random copolymer comprises a molecular weight of Mn no more than 3,500 Da, and Mw no more than 15,000.

In accordance with an embodiment of the present invention, the random copolymer comprises a molecular weight of Mn no less than 4,000 Da, Mw no less than 25,000 Da.

In accordance with an embodiment of the present invention, the polar and reactive segment D of the random copolymer includes maleic anhydride-modified monomers capable of reacting with hydroxyl or amine groups present in plastic contaminants, such as polyamide or PET.

In accordance with an embodiment of the present invention, the polar and reactive segment D of the random copolymer incorporates glycidyl-functionalized monomers designed to form covalent bonds with contaminants containing carboxylic acid or amide groups, such as those in polyethylene terephthalate (PET) and nylon-based fillers.

In accordance with an embodiment of the present invention, the soft and non-polar segment A of the random copolymer is present in an amount of 10-50 mol % and the segment B with middle rigidity is present in an amount of 10-50 mol %.

In accordance with an embodiment of the present invention, the hard segment C of the random copolymer is present in an amount of 5-50 mol % and the polar and reactive segment D is present in an amount of 5-50 mol %.

In accordance with an embodiment of the present invention, the dosage of the random copolymer compatibilizer is 0.5-10% by weight, preferably 1-5% by weight.

In accordance with an embodiment of the present invention, the formulation comprises a plurality of additives, a plurality of fillers and so forth for common plastic processing, such as stabilizers or anti-oxidative compounds, to protect the post-consumer recycled plastics from thermal and oxidative degradation during high-temperature recycling processes, such as impact modifier to enhance the impact strength, such as inorganic fillers like CaCO₃ and TiO₂.

Another embodiment of the present invention relates to a method for compatibilizing post-consumer recycled plastics. The method includes synthesizing a random copolymer represented by the structural formula (A)n(B)m(C)p(D)q. The n, m, p, and q are independently no less than 1, the random copolymer comprises a soft and non-polar segment A in a pre-determined amount, a segment B with middle rigidity in a pre-determined amount, a hard segment C in a pre-determined amount, and a polar and reactive segment D in a pre-determined amount. The synthesis includes radical polymerization based on a precursor followed by sediment separation in a solvent to isolate the desired random copolymer. The method also includes preheating the post-consumer recycled plastics to remove residual moisture and facilitate uniform mixing during blending. The method also includes blending the synthesized random copolymer with post-consumer recycled plastics containing mixed polymer types to prevent phase separation and stabilize the composition, and incorporating a plurality of additives, a plurality of fillers and common additive in the plastic industry, such as antioxidants and stabilizers, to enhance the durability and oxidative resistance of the recycled plastic composition. The method also includes processing the blended mixture through a plurality of plastic processes such as extrusion, film blowing, and injection molding. The method also includes adjusting processing parameters, including temperature and shear rate, to align with the thermal stability of the recycled plastics and random copolymer and ensure compatibility during recycling.

In accordance with an embodiment of the present invention, the method further comprises adding the random copolymer incrementally during the blending process to optimize the interaction between the compatibilizer and mixed plastics.

In accordance with an embodiment of the present invention, the method further comprises a plurality of functional additives, such as antioxidants and stabilizers, to enhance the durability and oxidative resistance of the recycled plastic composition.

In accordance with an embodiment of the present invention, the whole preparation process of random copolymer is performed under normal pressure and does not require high pressure.

In accordance with an embodiment of the present invention, the reaction temperature of the radical polymerization to prepare random copolymer is ranging from 50-100° C. and reaction time is ranging from 2-20 hours based on the reactivity of the monomers and the desired degree of polymerization.

In accordance with an embodiment of the present invention, the solvent used for sediment separation is different from the solvent used for the reaction and random copolymer product exhibits limited solubility in the solvent for sediment separation, wherein the solvent for sediment separation is selected from toluene, benzene, chlorobenzene, tetrahydrofuran, hexane, chloroform, diisopropyl ether, isopropanol, tert-butanol, acetone, or any combination thereof.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 illustrates a flowchart of the formulation for compatibilizing, in accordance with an embodiment of the present invention;

FIG. 2 illustrates a flowchart for the method for compatibilizing, in accordance with an embodiment of the present invention;

FIG. 3 illustrates a detailed view of an illustration of the universal compatibilizer based on random copolymer, in accordance with an embodiment of the present invention;

FIG. 4 illustrates a detailed view of an illustration of compatibilization of PCR plastics with universal compatibilizer, in accordance with an embodiment of the present invention,

FIGS. 5A and 5B illustrates a detailed view of a preparation method of random copolymer for compatibilizer based on precursor, in accordance with an embodiment of the present invention;

FIGS. 6A and 6B illustrates a thermal properties characterization of UC-1.1: TGA and DSC, in accordance with an embodiment of the present invention;

FIGS. 7A and 7B illustrates a GPC characterization of precursor of UC-1.1 and UC-1.1 respectively, in accordance with an embodiment of the present invention;

FIG. 8 illustrates a FTIR characterization of UC-1.1, in accordance with an embodiment of the present invention;

FIG. 9 illustrates a FTIR characterization of UC-2.1, in accordance with an embodiment of the present invention;

FIG. 10 illustrates a FTIR characterization of UC-3, in accordance with an embodiment of the present invention;

FIG. 11 illustrates a FTIR characterization of UC-4, in accordance with an embodiment of the present invention, and

FIGS. 12A and 12B illustrates a process of recycling of mixed PCR LDPE film waste, and an evaluation of UC-1.1 in upcycling of PCR LDPE for film blowing, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention,

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiment include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present invention

The terms “determining”, “measuring”, “evaluating”, “assessing,” “assaying,” and “analyzing” can be used interchangeably herein to refer to any form of measurement and include determining if an element is present or not. (e.g., detection). These terms can include both quantitative and/or qualitative determinations. Assessing may be relative or absolute.

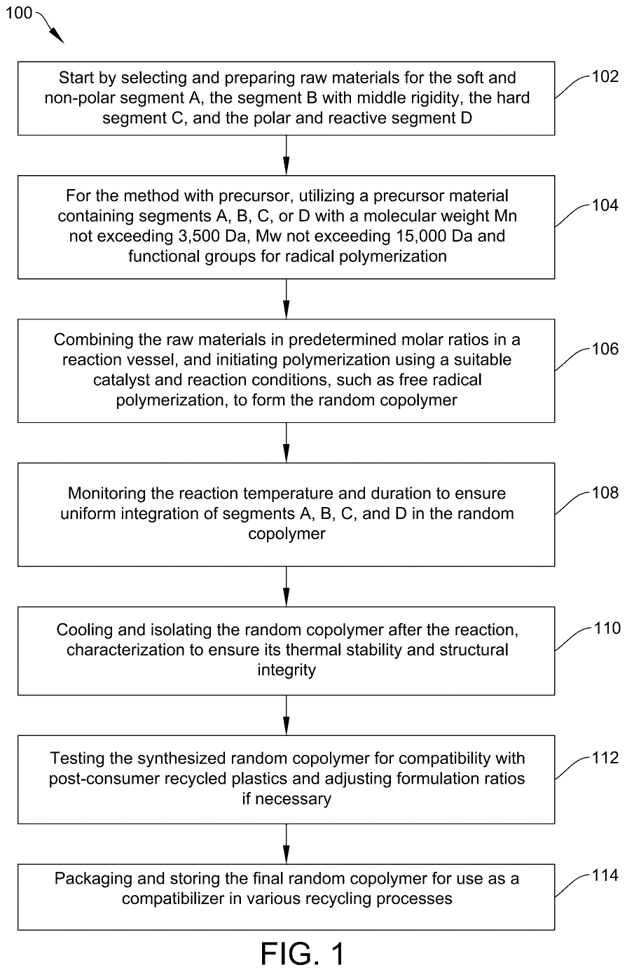

FIG. 1 illustrates a flowchart of the formulation 100 for compatibilizing post-consumer recycled plastics, in accordance with an embodiment of the present invention.

The formulation 100 may comprise a random copolymer represented by the structural formula (A)n(B)m(C)p(D)q. The n, m, p, and q may be independently no less than 1. The A, B, C, and D may be structurally different and arranged in a random sequence.

The formulation 100 may also comprise a plurality of recycled plastic.

The formulation 100 may also comprise a plurality of additives, a plurality of fillers and a combination thereof.

The formulation 100 may ensure universal compatibility with mixed post-consumer recycled plastics, reduces quality variations, enhances process stability, and improves mechanical properties, requiring a dosage of a pre-determined amount for efficient and sustainable recycling applications.

The random copolymers may be formed using a plurality of precursor material having one or more segments selected from A, B, C, and D, and containing reactive functional groups for further radical polymerization and the random copolymer comprises a soft and non-polar segment A, in a pre-determined amount, to enhance compatibility with low-density polyethylene (LDPE) and linear low-density polyethylene (LLDPE). The random copolymer also comprises a segment B with middle rigidity, in a pre-determined amount, to provide structural adaptation to high-density polyethylene (HDPE) and polypropylene (PP). The random copolymer also comprises a hard segment C, in a pre-determined amount, to reinforce compatibility with rigid plastics, including polystyrene (PS), polycarbonate (PC), and polyethylene terephthalate (PET). The random copolymer also comprises a polar and reactive segment D, in a pre-determined amount, to improve compatibility with polar plastics such as polyethylene terephthalate (PET), polycarbonate (PC), and inorganic fillers, including calcium carbonate (CaCO₃).

In accordance with an 3 embodiment of the present invention, the precursor is a random polymer or oligomer comprising one or more segments of the random copolymer.

In a preferred embodiment, the random copolymers are formed using a plurality of precursor material comprising one or more segments selected from A, B, C, and D, with a molecular weight of Mn no more than 3,500 Da and Mw no more than 15,000 and containing reactive functional groups for further radical polymerization.

The soft and non-polar segment A comprises hydrocarbon chains with main chain lengths from C4-C10, selected from butadiene, isoprene, pentene, hexene, octene, decyne, hexyl acrylate, and octyl acrylate.

The segment B with middle rigidity includes hydrocarbon chains with main chain lengths from C2-C4, selected from ethylene, propylene, butadiene, and isoprene.

The hard segment C includes aromatic groups selected from styrene, vinyl naphthalene, and norbornene.

The polar and reactive segment D includes polar reactive groups selected from maleic anhydride, methyl acrylate, glycidyl methacrylate, 2-acetoxyethyl methacrylate, and acrylic acid.

The simplified versions of the compatibilizer are selected from (A)n(B)m(C)p, (A)n(B)m(D)q, and (A)n(C)p(D)q for applications involving less contaminated post-consumer recycled plastics.

The random copolymer exhibits thermal stability with a glass transition temperature (Tg) of no more than 200° C. and a decomposition temperature (Td) of no less than 300° C.

The polar and reactive segment D includes but not limited to maleic anhydride-modified, glycidyl monomers capable of reacting with hydroxyl and amine groups present in plastic contaminants, such as polyamide and PET.

The formulation includes a plurality of additives, a plurality of fillers and a combination thereof for common plastic processing, such as stabilizers or anti-oxidative compounds, to protect the post-consumer recycled plastics from thermal and oxidative degradation during high-temperature recycling processes, such as impact modifier to enhance the impact strength, such as inorganic fillers like CaCO₃ and TiO₂. These compounds help maintain the integrity of the recycled plastic by reducing the breakdown of polymers that result from prolonged heat exposure. Impact modifiers also enhance the material's toughness, improving its ability to withstand mechanical stresses. Inorganic fillers like calcium carbonate (CaCO3) and titanium dioxide (TiO2) serve multiple functions, such as improving the rigidity and strength of the plastic, reducing production costs, and enhancing UV stability.

Based on the structure of random polymer, the soft and non-polar segment A is present in an amount of 10-50 mol % and the segment B with middle rigidity is present in an amount of 10-50 mol %.

Based on the structure of random polymer, the hard segment C is present in an amount of 5-50 mol % and the polar and reactive segment D is present in an amount of 5-50 mol %.

The method 100 may comprise the following steps.

At 102, start by selecting and preparing raw materials for the soft and non-polar segment A, the segment B with middle rigidity, the hard segment C, and the polar and reactive segment D.

At 104, for the method with precursor, utilize a precursor material containing segments A, B, C, and D with a molecular weight Mn not exceeding 3,500 Da, Mw not exceeding 15,000 Da and functional groups for radical polymerization.

At 106, combine the raw materials in predetermined molar ratios in a reaction vessel, and initiate polymerization using a suitable catalyst and reaction conditions, such as free radical polymerization, to form the random copolymer.

At 108, monitor the reaction temperature and duration to ensure uniform integration of segments A, B, C, and D in the random copolymer.

At 110, cool and isolate the random copolymer after the reaction, characterization to ensure its thermal stability and structural integrity.

At 112, test the synthesized random copolymer for compatibility with post-consumer recycled plastics and adjust formulation ratios if necessary.

At 114, package and store the final random copolymer for use as a compatibilizer in various recycling processes.

The present formulation and method for computerizing post-consumer recycled plastics using random copolymers address challenges in recycling mixed post-consumer recycled plastics, where contamination, incompatibility, and variability in mechanical properties hinder the production of high-quality recycled materials. The formulation utilizes a random copolymer comprising a soft and non-polar segment A, a segment B with middle rigidity, a hard segment C, and a polar and reactive segment D. Each of these segments performs a critical role in ensuring compatibility across a wide range of plastics and contaminants.

The soft and non-polar segment A enhances compatibility with non-polar plastics such as low-density polyethylene and linear low-density polyethylene. The soft and non-polar segment A comprises hydrocarbon chains with chain lengths from C4 to C10, such as 1,3-butadiene, 1-hexene, and 1-octene. This segment is present in the formulation in an amount ranging from 10 to 50 mol %. The inclusion of the soft and non-polar segment A ensures flexibility and dispersion of non-polar components within the recycled plastic matrix. This segment interacts effectively with waxy components and non-polar additives, promoting a homogeneous blend.

The segment B with middle rigidity provides structural adaptation to medium-rigidity plastics such as high-density polyethylene and polypropylene. The segment B includes hydrocarbon chains with chain lengths from C2 to C4, selected from ethylene, propylene, and 1,3-butadiene. The segment B is present in an amount ranging from 10 to 50 mol %. This segment facilitates adhesion at the interface between polyethylene and polypropylene phases in the recycled plastic blend, ensuring uniform mechanical properties and reducing interfacial stress. The segment B balances the flexibility of the soft and non-polar segment A with the rigidity of the hard segment C.

The hard segment C reinforces compatibility with rigid plastics, including polystyrene, polycarbonate, and polyethylene terephthalate. The hard segment C comprises aromatic groups such as styrene, vinyl naphthalene, and norbornene, and is included in the formulation in an amount ranging from 5 to 50 mol %. The hard segment C provides structural reinforcement, ensuring that the recycled plastic composition maintains its integrity in high-stress applications. The inclusion of cross-linkable aromatic groups, such as divinylbenzene or norbornene, enhances the strength and rigidity of the recycled material.

The polar and reactive segment D improves compatibility with polar plastics and inorganic fillers. The polar and reactive segment D comprises functional groups such as maleic anhydride, methyl acrylate, glycidyl methacrylate, 2-acetoxyethyl methacrylate, and acrylic acid, and is present in the formulation in an amount ranging from 5 to 50 mol %. This segment interacts chemically with contaminants containing functional groups such as hydroxyl, carboxylic acid, and amide groups, ensuring their uniform dispersion within the recycled plastic matrix. The polar and reactive segment D also addresses the compatibility of inorganic fillers, such as calcium carbonate, commonly found in post-consumer recycled plastics. By forming secondary chemical bonds, the polar and reactive segment D stabilizes the dispersion of these fillers, minimizing quality variation.

The random copolymer is synthesized using conventional free radical polymerization, which ensures scalability and cost-effectiveness, wherein the whole preparation process of random copolymer is performed under normal pressure, without the requirement of high pressure. The polymerization process involves combining the raw materials for the soft and non-polar segment A, the segment B with middle rigidity, the hard segment C, and the polar and reactive segment D in predetermined molar ratios. The polymerization reaction is conducted under controlled temperature and pressure conditions to achieve uniform integration of the segments along the polymer chain. The random distribution of the segments maximizes interaction with various incompatible components in post-consumer recycled plastics, enhancing their compatibility.

The thermal properties of the random copolymer are optimized to ensure compatibility with common plastic processing methods. The glass transition temperature of the random copolymer is no more than 200° C., and the decomposition temperature is no less than 300° C. These thermal properties allow the random copolymer to maintain its functionality during high-temperature common plastic processes, such as extrusion, film blowing, and injection molding. The random copolymer exhibits excellent thermal stability, preventing degradation during processing and ensuring consistent performance.

The formulation improves the quality and processability of post-consumer recycled plastics. The random copolymer enables uniform dispersion of contaminants within the recycled plastic matrix, reducing phase separation and ensuring stable melt flow. The formulation is effective with a low dosage of 0.5 to 10% by weight, preferably 1 to 5% by weight, making it cost-efficient for large-scale recycling operations. The inclusion of functionalized derivatives, such as hydrogenated polybutadiene in the soft and non-polar segment A, and glycidyl-functionalized monomers in the polar and reactive segment D, further enhances the performance of the formulation.

The method of application involves blending post-consumer recycled plastics with the random copolymer under controlled conditions. The process begins with preheating the recycled plastics to remove residual moisture and ensure uniform mixing. The random copolymer is added to the preheated plastics in incremental amounts during the blending process to optimize interaction with the various components. The blended mixture is then processed through mechanical recycling methods and common plastic processes, such as extrusion, film blowing, or injection molding. Processing parameters, including temperature and shear rate, are adjusted to align with the thermal stability of the random copolymer and recycled plastics, ensuring compatibility and preventing degradation.

The formulation addresses specific challenges associated with mixed post-consumer recycled plastics, such as contamination and incompatibility due to differences in polarity and rigidity. The formulation provides a universal solution by leveraging the unique properties of the soft and non-polar segment A, the segment B with middle rigidity, the hard segment C, and the polar and reactive segment D. Each segment contributes to the overall performance of the random copolymer, ensuring compatibility with a wide range of plastics, including low-density polyethylene, high-density polyethylene, polypropylene, polystyrene, polycarbonate, polyethylene terephthalate, and their combinations.

The formulation incorporate a plurality of functional additives, a plurality of fillers and a combination thereof, other than the random copolymer, common additives in plastic industry, such as stabilizers and anti-oxidative compounds. These additives enhance the durability and longevity of the recycled plastic composition, making it suitable for high-performance applications. The formulation's versatility allows it to be used with various forms of recycled plastics, including films, foams, containers, bottles, fibers, and sheets.

The formulation provides practical benefits for the recycling industry by reducing the need for extensive sorting, separation and analysis of mixed plastics. The random copolymer works as a universal compatibilizer simplifies the recycling process, allowing recyclers to process mixed plastic waste streams with unknown contaminants. The formulation's ability to address multiple incompatibility challenges within a single processing step eliminates the need for separate compatibilizers, streamlining operations and reducing costs.

This formulation for compatibilizing post-consumer recycled plastics using random copolymers ensures compatibility across a wide range of plastics and fillers, improving the quality and sustainability of recycled materials. The systematic design and tailored functionality make it a valuable tool for the recycling industry, addressing the growing need for efficient and cost-effective recycling solutions.

The random copolymer, universal compatibilizer, demonstrates exceptional performance in enhancing the recycling efficiency of post-consumer recycled plastics through systematic characterization and evaluation. The universal compatibilizer (UC), represented by the structural formula (A)n(B)m(C)p(D)q, is structured with a soft and non-polar segment A, a segment B with middle rigidity, a hard segment C, and a polar and reactive segment D. Each segment is tailored to improve compatibility with a range of plastic matrices, including low-density polyethylene, high-density polyethylene, polypropylene, and polyethylene terephthalate, as well as fillers such as calcium carbonate.

The chemical structure and functionality of the universal compatibilizer are validated using Fourier Transform Infrared Spectroscopy (FTIR) and Proton Nuclear Magnetic Resonance Spectroscopy (1H NMR). FTIR analysis reveals characteristics of stretching vibrations and functional group peaks. For example, for UC-1 and UC-2, peaks at 1639 cm⁻¹ and 2848-3075 cm⁻¹ are indicative of C═C bonds and alkene C—H stretching, respectively, indicating the segment from butadiene, and the peaks at 1493 cm⁻¹ and 1601 cm⁻¹ are related to benzene skeletal stretching vibrations of polystyrene, while for UC-2, the absorption bands at 1780 cm⁻¹ and 1858 cm⁻¹ correspond to C═O stretching of maleic anhydride, confirming the presence of polar and non-polar functionalities integral to its performance. The 1H NMR spectra further corroborate these findings by showcasing chemical shifts unique to the functionalized monomers in each segment, such as butadiene, styrene, glycidyl methacrylate and maleic anhydride.

The molecular weight Mn and Mw, and polydispersity index (PDI) of the random copolymer are studied by GPC, and they are determined to optimize their performance in recycling applications, the molecular weight should be controlled with consideration of thermal properties, such as glass transition temperature, and decomposition temperature, such that the random copolymer is further used as compatibilizer in recycled plastic processing.

In accordance with an embodiment of the present invention, the precursor material for the preparation of the random copolymer comprises a molecular weight of Mn no more than 3,500 Da, and Mw no more than 15,000.

Thermal analysis using Thermogravimetric Analysis (TGA) and Differential Scanning Calorimetry (DSC) highlights the universal compatibilizer's robustness under high-temperature conditions. For example, the TGA results for UC-1.1 demonstrate a decomposition temperature (Td) of approximately 459° C., ensuring its integrity during extrusion, film blowing, and injection molding processes. The glass transition temperature (Tg) of UC-1.1 is measured at −69° C., which contributes to its flexibility and compatibility across various plastic phases. UC-2.1 exhibits similar thermal properties, with a decomposition temperature (Td) of 423° C. and a glass transition temperature (Tg) of −69° C., confirming its versatility in similar applications.

The evaluation of random copolymers as compatibilizers in recycling systems reveals significant improvements in process stability and material properties. For example, in trials involving the upcycling of post-consumer recycled polyethylene films and bags, which typically contain a mixture of low-density polyethylene, high-density polyethylene, polypropylene, and calcium carbonate fillers, the universal compatibilizer demonstrates remarkable performance. UC-1.1 enhances the stability of the film-blowing process, reducing deviations in tensile strength from 2.13 MPa to 1.05 MPa and reducing deviations in elongation at break from 131.22% to 33.70%. Additionally, the overall tensile strength improves, reaching an average value of 14.174 MPa, while the elongation at break achieves an average of 571.39%, underscoring its ability to homogenize and stabilize the recycled plastic composition.

The universal compatibilizer also supports a broad range of recycling applications. Simplified compatibilizer variants, such as (A)n(B)m(C)p, (A)n(B)m(D)q, and (A)n(C)p(D)q, are optimized for less contaminated plastic waste streams. These formulations retain essential functionalities while providing cost-effective solutions for specific recycling challenges. Furthermore, the compatibilizer demonstrates compatibility with multiple forms of recycled plastics, including films, foams, containers, and bottles, and exhibits effective performance across various processing methods, such as extrusion, film blowing, and injection molding.

Additionally, the universal compatibilizer's ability to interact chemically with contaminants, such as carboxylic acid and amide groups in polyethylene terephthalate and polyamide, further stabilizes the recycled matrix, reducing property deviation and enhancing mechanical performance.

In summary, the universal compatibilizer, for example UC-1 and UC-2, represent a significant advancement in recycling technology. Their tailored structure, validated through comprehensive characterization, and exceptional thermal and mechanical properties position them as indispensable tools for improving the efficiency and quality of post-consumer recycled plastics.

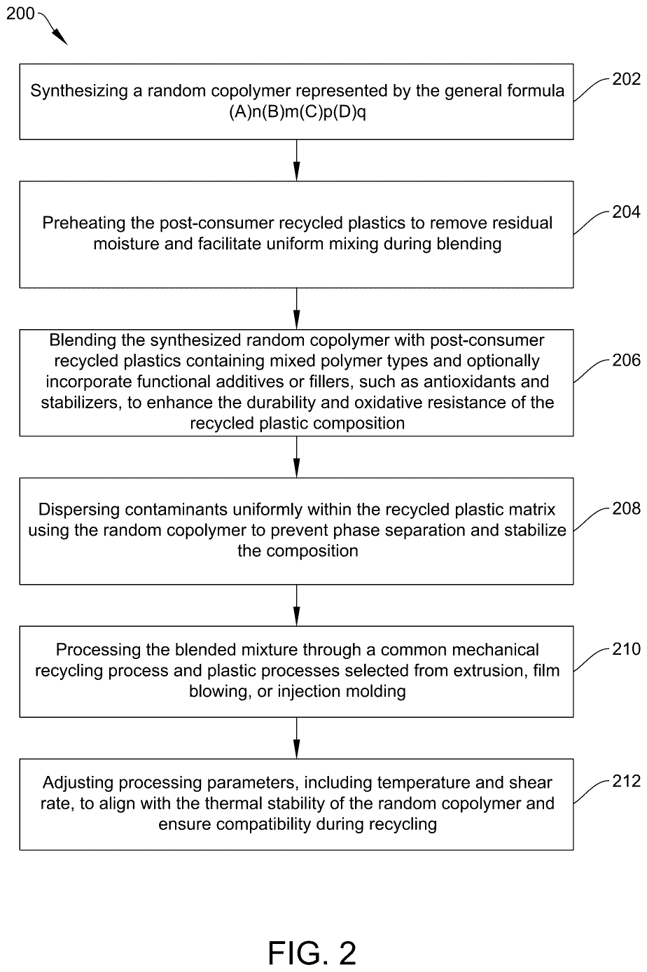

FIG. 2 illustrates a flowchart for the method for compatibilizing, in accordance with an embodiment of the present invention.

At 202, synthesizing a random copolymer represented by the structural formula (A)n(B)m(C)p(D)q. The n, m, p, and q may independently be no less than 1, the random copolymer comprises a soft and non-polar segment A in a pre-determined amount, a segment B with middle rigidity in a pre-determined amount, a hard segment C in a pre-determined amount, and a polar and reactive segment D in a pre-determined amount. The synthesis may include radical polymerization followed by sediment separation in a solvent to isolate the desired random copolymer.

At 204, preheating the post-consumer recycled plastics to remove residual moisture and facilitate uniform mixing during blending.

At 206, blending the synthesized random copolymer with post-consumer recycled plastics containing mixed polymer types and incorporating a plurality of functional additives, a plurality of fillers and a combination thereof, such as antioxidants and stabilizers, to enhance the durability and oxidative resistance of the recycled plastic composition.

In an embodiment of the present disclosure, preparing the random copolymer from a precursor material comprising one or more segments selected from A, B, C, D, wherein the precursor material comprises a molecular weight of no more than 3,500 Da and Mw no more than 15,000 and contains reactive functional groups for further radical polymerization. The radical polymerization may further include sediment separation in a solvent to obtain the desired random copolymer.

At 208, dispersing contaminants uniformly within the recycled plastic matrix using the random copolymer to prevent phase separation and stabilize the composition.

At 210, processing the blended mixture through a plurality of recycling process and a plurality of common plastic processes selected from extrusion, film blowing, or injection molding.

At 212, adjusting processing parameters, including temperature and shear rate, to align with the thermal stability of the random copolymer and recycled plastic and ensure compatibility during recycling.

The method 200 may further comprise adding the random copolymer incrementally during the blending process to optimize the interaction between the compatibilizer and mixed plastics.

The method 200 may further comprise introducing a plurality of functional additives, a plurality of fillers and a combination thereof, common additives in plastic industry such as antioxidants and stabilizers, to enhance the durability and oxidative resistance of the recycled plastic composition.

In the synthesis of random copolymer for compatibilizer, the sediment separation may include re-apply the random copolymer in the solvent to perform purification and isolation of the random copolymer, the solvent used is different from the solvent used in the reaction mixture.

The whole preparation process for random copolymer is based on radical polymerization, which is performed under normal pressure, and without the requirement of high pressure.

The method of the radical polymerization, wherein the solvent for the radical polymerization is selected from benzene, chlorobenzene, toluene, tetrahydrofuran, hexane, and diisopropyl ether; wherein the initiator for the radical polymerization is selected from azobisisobutyronitrile, dicumyl peroxide, tert-butyl peroxybenzoate, tert-butyl peroxide, and benzoyl peroxide.

The reaction temperature of the radical polymerization may be ranging from 50-100° C. and reaction time is ranging from 5-20 hours based on the reactivity of the monomers and the desired degree of polymerization.

The solvent used for sediment separation is different from the solvent used for the reaction and random copolymer product exhibits limited solubility in the solvent for sediment separation, wherein the solvent for sediment separation is selected from toluene, benzene, chlorobenzene, tetrahydrofuran, hexane, chloroform, diisopropyl ether, isopropanol, tert-butanol, acetone and any combination thereof.

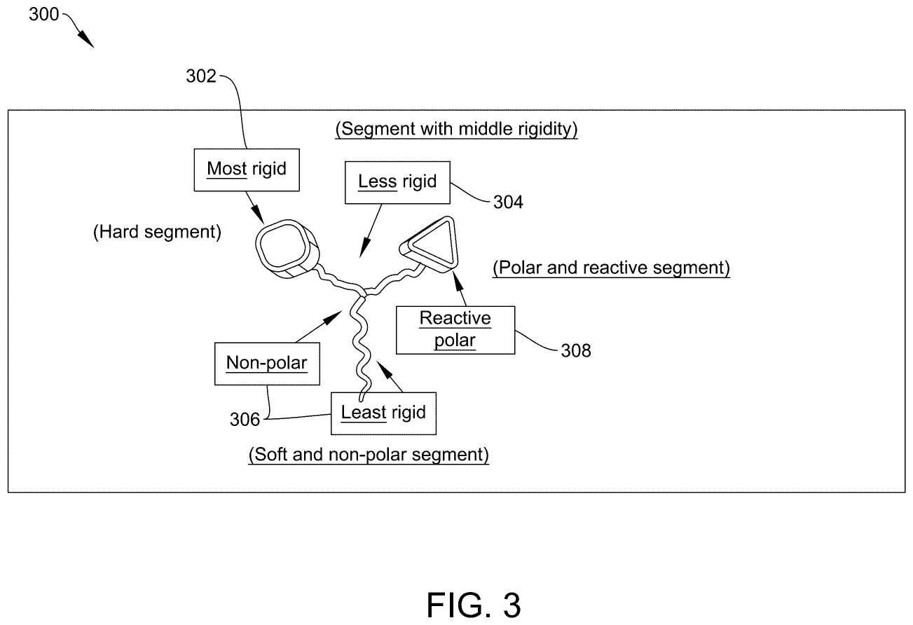

FIG. 3 illustrates a detailed view of an illustration of the universal compatibilizer based on random copolymer, in accordance with an embodiment of the present invention.

The most rigid segment 302 is illustrated as a fundamental part of the universal compatibilizer based on a random copolymer. The most rigid segment 302, hard segment C demonstrates the highest structural rigidity among all the segments, making it essential for the overall stability and durability of the universal compatibilizer. The rigidity of the most rigid segment 302 ensures that it provides the required structural robustness to interact effectively with various materials. The most rigid segment 302 works as the hard segment in the random copolymer based universal compatibilizer in providing a solid framework for compatibility with different rigid polymer systems.

The less rigid segment 304, segment B with middle rigidity, positioned adjacent to the most rigid segment 302, offers a reduced level of rigidity, creating a balance between flexibility and structural stability within the universal compatibilizer. The less rigid segment 304 acts as a transitional component, bridging the gap between the more rigid and the softer segments. This unique role of the less rigid segment 304 enables the random copolymer to adapt to various material interfaces while maintaining its mechanical strength. The less rigid segment 304 contributes significantly to enhancing the interfacial adhesion and mechanical compatibility of the universal compatibilizer, ensuring its effectiveness in diverse applications. The flexibility provided by the less rigid segment 304 makes it indispensable for the efficient functioning of the universal compatibilizer.

The non-polar and least rigid segment 306, segment A, depicted as a soft and flexible component, provides the universal compatibilizer with its essential non-polar characteristics, represented as the softest and most flexible component of the universal compatibilizer. The non-polar segment 306 reduces the overall polarity of the universal compatibilizer, making it suitable for applications in hydrophobic environments. The non-polar segment 306 is specifically engineered to interact with non-polar substances, optimizing the chemical compatibility of the random copolymer. The least rigid segment 306 enhances the elasticity and adaptability of the universal compatibilizer, allowing it to conform to varying shapes and material properties. The least rigid segment 306 plays a crucial role in improving the mechanical flexibility of the random copolymer, ensuring its consistent performance in diverse applications. The least rigid segment 306 also minimizes internal stress within the universal compatibilizer, making it integral for maintaining its structural integrity over prolonged use. The flexible nature of the non-polar segment 306 allows for enhanced accommodation of molecular motion, making it a versatile and essential component within the universal compatibilizer for various functional environments, providing compatibility with flexible and non-polar polymer system.

The reactive polar segment 308 introduces a significant feature within the universal compatibilizer by enabling active chemical bonding with polar substances. The reactive polar segment 308 ensures that the universal compatibilizer achieves effective compatibility between dissimilar materials by enhancing its ability to interact with polar agents. The reactive polar segment 308 is designed to provide the universal compatibilizer with dynamic functionality, extending its applicability to complex systems. By incorporating the reactive polar segment 308, the universal compatibilizer demonstrates an improved ability to adapt and function effectively in diverse operational contexts and provides compatibility with polar polymer system and polar inorganic fillers.

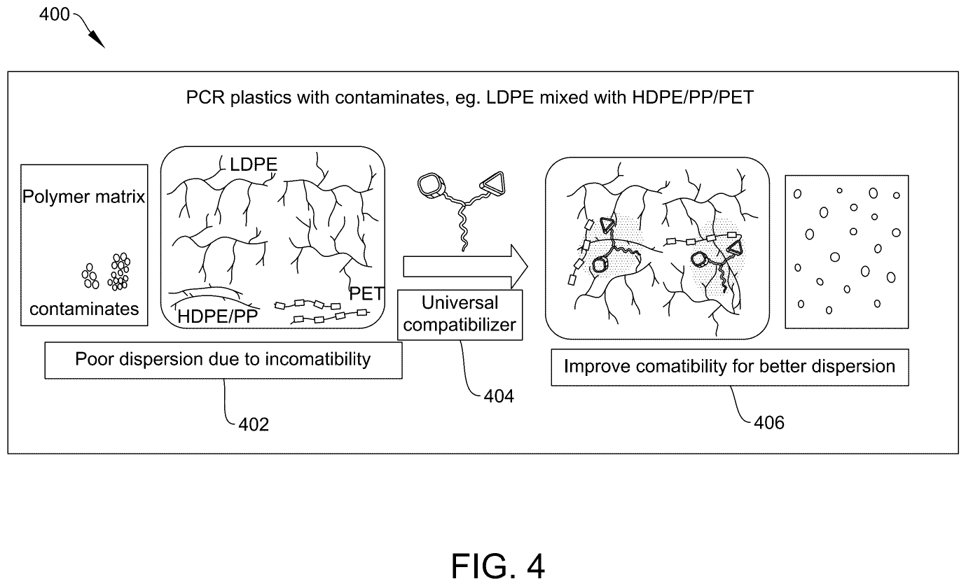

FIG. 4 illustrates a detailed view of an illustration of compatibilization of PCR plastics with universal compatibilizer, in accordance with an embodiment of the present invention.

The poor dispersion due to incompatibility 402 refers to the challenge encountered in processing post-consumer recycled plastics when mixed with different polymer types such as LDPE, HDPE, PP, and PET. The incompatibility between these polymers results in weak intermolecular interactions, leading to an uneven distribution of contaminants within the polymer matrix. The poor dispersion due to incompatibility 402 affects the mechanical, structural properties and especially the quality variation of the final product, making the product higher quality variation, less durable and less suitable for practical applications. The poor dispersion due to incompatibility 402 arises due to the inherent differences in polarity, molecular weight, and structural rigidity between the mixed polymers and the contaminants. The poor dispersion due to incompatibility 402 highlights the necessity for an effective solution to enhance the compatibility between diverse polymer types.

The universal compatibilizer 404 is engineered to address the incompatibility issues faced during the processing of post-consumer recycled plastics. The universal compatibilizer 404 achieves this by introducing molecular components that bridge the differences between polymers such as LDPE, HDPE, PP, and PET. The universal compatibilizer 404 contains segments that interact selectively with polar and non-polar polymers, forming a stable interface between them. The universal compatibilizer 404 promotes homogeneous dispersion of contaminants within the polymer matrix, ensuring improved interfacial adhesion and mechanical properties. The universal compatibilizer 404 plays a critical role in maintaining structural integrity and enhancing the overall performance of the recycled plastic material.

The improve compatibility for better dispersion 406 refers to the result achieved by incorporating the universal compatibilizer 404 into the polymer matrix. The improved compatibility for better dispersion 406 ensures a uniform distribution of contaminants within the recycled plastic, thereby enhancing its mechanical, thermal, and aesthetic properties. The improve compatibility for better dispersion 406 allows the recycled material to exhibit characteristics comparable to virgin polymers, making the material suitable for a wide range of applications. The improved compatibility for better dispersion 406 underscores the effectiveness of the universal compatibilizer 404 in overcoming incompatibility challenges and optimizing the quality of post-consumer recycled plastics.

The disclosed invention may be designed as universal compatibilizer to address the incompatibility problems in actual post-consumer recycled (PCR) plastics with different potential mixed PCR plastics and/or fillers., the exact contaminates may usually be unknown and unrealistic to fully analyzed, with a high chance of suffering differences of both structure polarity and rigidity in the mixed PCR plastics, also, inorganic fillers such as CaCO₃ may commonly be used in plastics and thus the compatibility of inorganic fillers may also be needed to be considered in recycling of PCR plastics.

The universal compatibilizers may be based on random copolymers with a structural formula of (A)ₙ(B)ₘ(C)ₚ(D)_{q}, comprises a soft and non-polar segment A to provide affinity to soft and non-polar plastics such as low-density polyethylene (e.g. LLDPE, LDPE), a segment B with middle rigidity to provide affinity to plastics with middle rigidity, such as high-density polyethylene (HDPE), polypropylene (PP), a hard segment C to provide affinity to rigid plastics such as polystyrene (PS), polycarbonate (PC), polyethylene terephthalate (PET), and a polar and reactive segment D to provide affinity to polar plastics such as polycarbonate (PC), polyethylene terephthalate (PET), and inorganic fillers such as CaCO₃.

The copolymer (A)ₙ(B)ₘ(C)ₚ(D)_{q} may serve for this kind of recycled plastics working as a universal compatibilizer providing versatile compatibilization for various plastics. Universal compatibilizer (A)ₙ(B)ₘ(C)ₚ(D)_{q} may provide a versatile, general and convenient solution for the plastic recycling industry, without the need of a full analysis of the impurities. The mole ratio of A, B, C and D may be demonstrated as n, m, p and q, wherein compatibilizers with different mole ratio of A, B, C and D are designed for different scenarios. For example, in one embodiment, recycled LLDPE/LDPE is known to be the major recycling plastics, wherein there are other unknown impurities, the compatibilizer (A)ₙ(B)ₘ(C)ₚ(D)_{q} may be designed with segment A as the largest mole ratio.

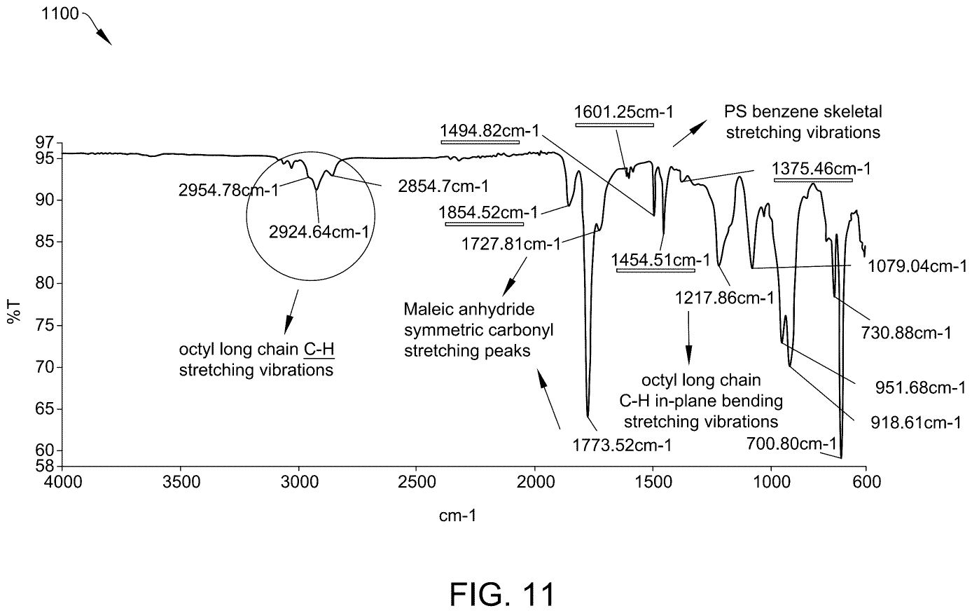

In some embodiments, wherein the recycled plastics may be less complicated with known impurities in some recycling system, the universal compatibilizer may be designed as copolymers with three segments, such as (A)ₙ(B)ₘ(C)ₚ, (A)ₙ(B)ₘ(D)_{q}, (A)ₙ(C)ₚ(D)_{q}, (A)ₙ(B)ₘ(D)_{q}. For example, in a recycling site where post-consumer recycled (PCR) films may be collected and recycled into pellets, wherein the PCR films are known to be mainly LDPE, LLDPE films according to the recycled sources, wherein there are also some HDPE films and PP films potentially contaminating in the recycled sources, also wherein there are only a few films may contain commonly used CaCO₃ in the films. In this embodiment, a compatibilizer (A)ₙ(B)ₘ(C)_{q}, such as UC-1, with segments A, B and C for affinity of LDPE/LLDPE, HDPE/PP respectively, may be designed for this kind of scenario to provide better compatibility, as shown in FIG. 11, UC-1.1 enhances the stability of the film-blowing process, reducing deviations in tensile strength from 2.13 MPa to 1.05 MPa and reducing deviations in elongation at break from 131.22% to 33.70%. Additionally, the overall tensile strength improves, reaching an average value of 14.17 MPa, while the elongation at break achieves an average of 571.39%, underscoring its ability to homogenize and stabilize the recycled plastic composition. Nevertheless, the general universal compatibilizer (A)ₙ(B)ₘ(C)ₚ(D)_{q}, such as UC-2, may be expected to be also applicable in the above example, also providing better compatibility compared to without any compatibilizers, UC-2 enhances the stability of the film-blowing process, reducing deviations in tensile strength from 2.13 MPa to 1.39 MPa and reducing deviations in elongation at break from 131.22% to 44.40%. Additionally, the overall tensile strength improves, reaching an average value of 14.79 MPa, while the elongation at break achieves an average of 582.82%, underscoring its ability to homogenize and stabilize the recycled plastic composition.

The universal compatibilizer may be applied in different post-consumer recycled plastics, comprises low-density polyethylene (LDPE), linear low-density polyethylene (LLDPE), high-density polyethylene (HDPE), polypropylene (PP), polystyrene (PS), high-impact polystyrene (HIPS), polyethylene terephthalate (PET), polyethylene terephthalate glycol (PETG), polyamides (PA), polycarbonate (PC), polyvinyl chloride (PVC), acrylonitrile butadiene styrene (ABS), and any combination thereof; wherein the PCR plastics may not in a single component with contamination of other plastics and fillers; wherein the PCR plastic scraps and pellets are from different plastic product forms, comprises but not limited to films, boxes, foams, containers, wovens, fibers, sheets, casings, bottles, and any combination thereof.

The universal compatibilizer may be used in different PCR plastics to improve the compatibility of the PCR plastic to provide a more stable quality in terms of melt flow rate, stable processability and lower variation in mechanical properties, with a low dosage of compatibilizer, i.e., 0.5-10% by weight, preferably 1-5% by weight. The universal compatibilizer may be applied in different post-consumer recycled plastics, as an additive alone, or together with other common polymer processing additives such as impact modifier, antioxidant, and so, through common plastic melt processing, such as extrusion, film blowing, injection molding, melt internal mixing, and more.

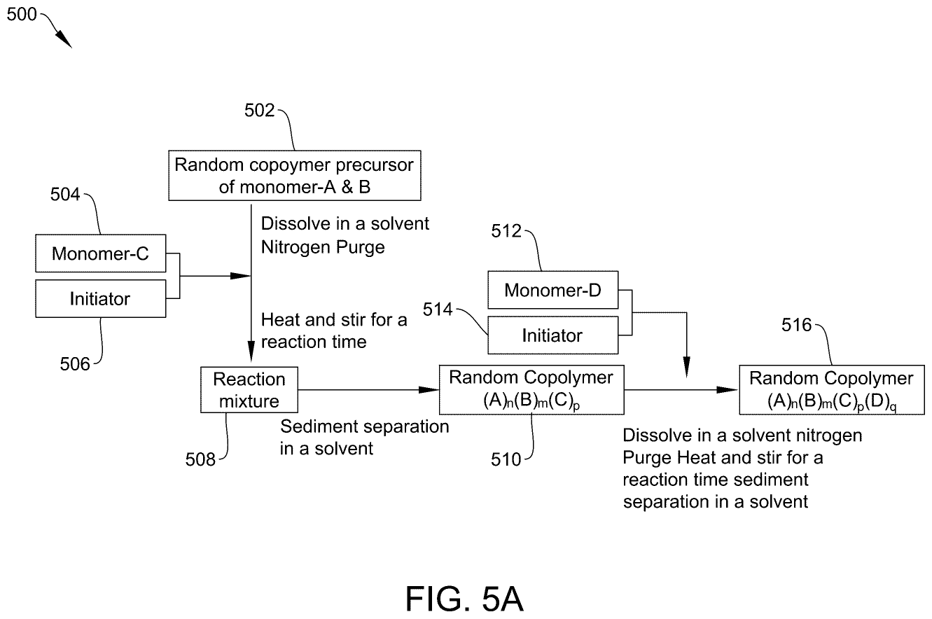

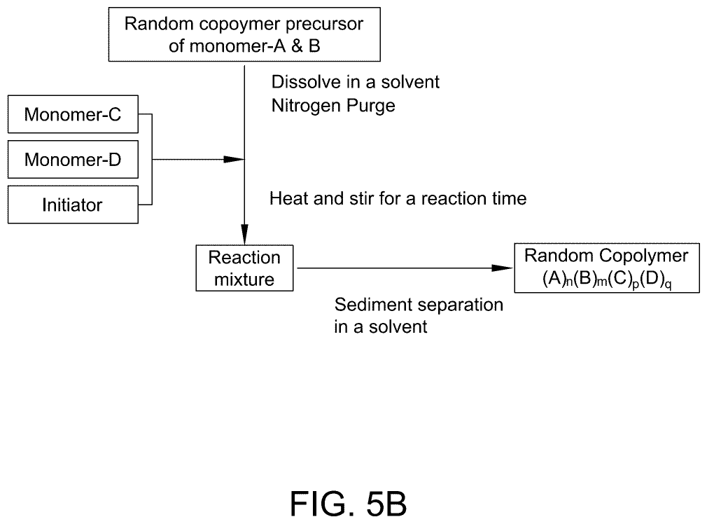

FIGS. 5A and 5B illustrates a detailed view of a preparation method of random copolymer as universal compatibilizer synthesized based on precursor, in accordance with an embodiment of the present invention.

In the stepwise method shown in FIG. 5A, the random copolymer precursor of monomer—A&B 502 is prepared by radical polymerization by dissolving the monomer in a suitable solvent under controlled conditions, wherein the solvent for the radical polymerization is selected from benzene, chlorobenzene, toluene, tetrahydrofuran, hexane, and diisopropyl ether.

The random copolymer precursor of 502 with segment A&B undergoes a nitrogen purge to eliminate any residual oxygen, ensuring an inert environment for the reaction.

Monomer-C 504 is a crucial component in the preparation process. Monomer-C 504 interacts with the random copolymer precursor of 502 under specific conditions to facilitate the formation of a stable copolymer matrix. Monomer-C 504 is introduced alongside initiator 506, enabling controlled polymerization by creating a reaction pathway that maintains consistency in molecular weight distribution and chemical bonding.

Initiator 506 serves as the driving force for the polymerization reaction, facilitating the interaction between the random copolymer precursor of 502 and monomer-C 504. Initiator 506 generates free radicals that enable the reaction mixture to achieve the necessary molecular activation. Initiator 506 ensures the polymerization reaction progresses efficiently and evenly, reducing the chances of irregularities or incomplete bonding within the copolymer structure, wherein the initiator for the radical polymerization is selected from azobisisobutyronitrile, dicumyl peroxide, tert-butyl peroxybenzoate, tert-butyl peroxide, and benzoyl peroxide.

The reaction mixture 508 is subjected to continuous stirring and controlled heating to maintain uniformity during the reaction process. The reaction mixture 508 undergoes sediment separation in a solvent after the reaction is complete, ensuring the purity of the resulting copolymer structure.

The random copolymer (A)n(B)m(C)p 510 is obtained by the successful polymerization of the random copolymer precursor of monomer—A&B 502 and monomer-C 504, facilitated by initiator 506. The random copolymer (A)n(B)m(C)p 510 exhibits enhanced compatibility properties, making it a suitable intermediate for further modification with additional monomers.

Monomer-D 512 is introduced to the random copolymer (A)n(B)m(C)p 510 for the subsequent reaction phase. Monomer-D 512, combined with initiator 514, enables the expansion of the copolymer matrix by incorporating new molecular structures that enhance performance characteristics. Monomer-D 512 interacts with the existing random copolymer structure to achieve a final product with tailored properties.

Initiator 514 facilitates the interaction between monomer-D 512 and the random copolymer (A)n(B)m(C)p 510, generating a controlled reaction environment. Initiator 514 ensures uniform polymerization, leading to the synthesis of random copolymer (A)n(B)m(C)p(D)q 516 with improved molecular compatibility.

The random copolymer (A)n(B)m(C)p(D)q 516 represents the final product of the polymerization process. The random copolymer (A)n(B)m(C)p(D)q 516 achieves a balanced structure and enhanced functional properties due to the systematic incorporation of monomers. The random copolymer (A)n(B)m(C)p(D)q 516 undergoes sediment separation in a solvent to ensure purity, resulting in a material suitable for use as a compatibilizer in various polymer applications. The solvent used may be different from the solvent used in the reaction mixture.

FIG. 5B illustrates a one-step preparation method based on precursor, wherein monomer-C and monomer-D are combined with initiator and introduced to the solution of precursor with segment A&B, leading to the synthesis of random copolymer (A)n(B)m(C)p(D)q.

By adjusting the amount of monomer of radical polymerization, the ratio of segment A, B, C and D are controlled in the random copolymer (A)n(B)m(C)p(D)q.

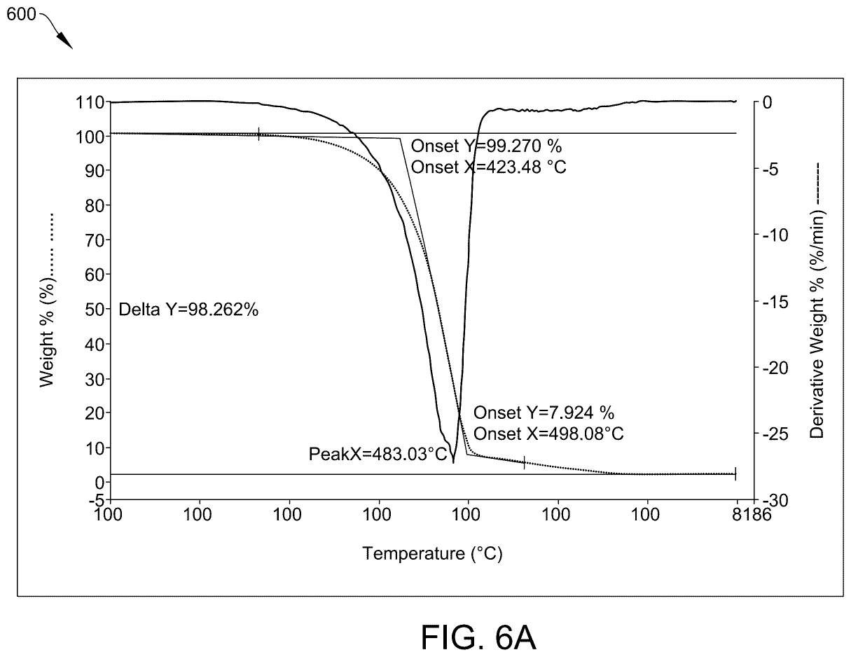

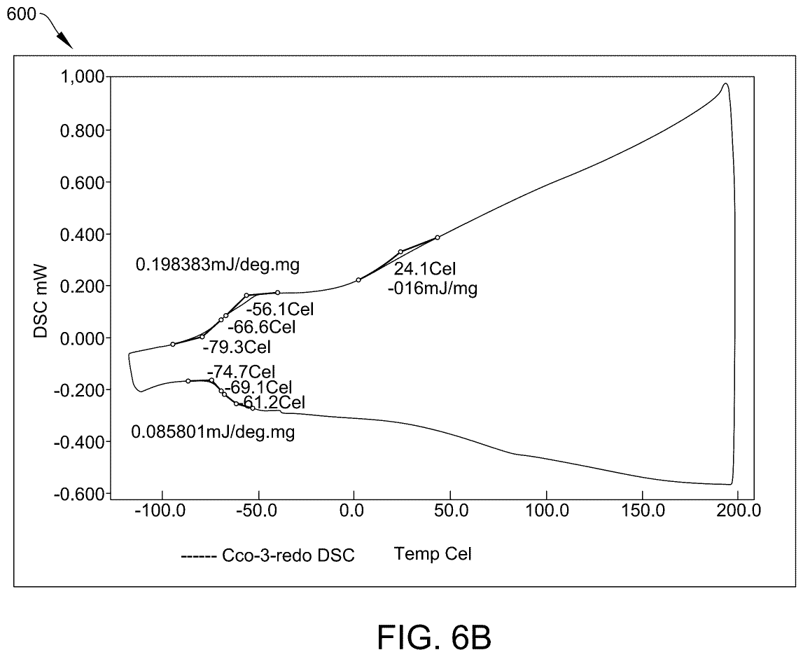

FIGS. 6A and 6B illustrates a thermal properties characterization of UC-1.1 as an example: TGA and DSC, in accordance with an embodiment of the present invention.

FIG. 6A illustrates a thermal properties characterization of UC-1.1: TGA, in accordance with an embodiment of the present invention.

The thermal properties characterization of universal compatibilizer (UC) through thermogravimetric analysis illustrates the thermal stability and decomposition behavior of the universal compatibilizer (UC) material. The thermogravimetric analysis characterizes the mass loss of the universal compatibilizer (UC) material as a function of increasing temperature under a controlled atmosphere. The thermal analysis equipment operates by continuously measuring the weight of the universal compatibilizer (UC) material as it undergoes heating, providing precise information about thermal degradation patterns. The heating process for the universal compatibilizer (UC) material follows a linear temperature ramp, ensuring that the analysis provides accurate thermal stability data. The thermogravimetric analysis records the temperature at which the universal compatibilizer (UC) material begins to exhibit significant mass loss, indicating the initial onset of thermal decomposition. The analysis identifies the stages of thermal degradation by detecting distinct weight loss events corresponding to different temperature ranges, which are directly related to the decomposition of specific components within the universal compatibilizer (UC) material. The thermal stability of the universal compatibilizer (UC) material is quantitatively measured by determining the percentage of mass retained at various temperature intervals, offering insights into the thermal performance of the material under elevated temperatures. The thermogravimetric analysis also highlights the residue formed after complete thermal degradation of the universal compatibilizer (UC) material, which provides additional information about the material's composition and inert content. The data generated by the thermogravimetric analysis of the universal compatibilizer (UC) material is graphically represented as a curve, which plots the percentage mass retained against the corresponding temperature. The curve provides clear indications of the thermal decomposition profile of the universal compatibilizer (UC) material, revealing critical temperature thresholds where structural changes occur. The thermal properties characterization using thermogravimetric analysis validates the suitability of the universal compatibilizer (UC) material for applications requiring high thermal stability, confirming its effectiveness in environments exposed to extreme thermal conditions.

FIG. 6B illustrates a thermal properties characterization of UC-1.1: DSC, in accordance with an embodiment of the present invention.

The thermal properties characterization of universal compatibilizer (UC) through differential scanning calorimetry illustrates the heat flow behavior of the universal compatibilizer (UC) material in response to changes in temperature under controlled conditions. The differential scanning calorimetry characterizes the thermal transitions of the universal compatibilizer (UC) material, including melting, crystallization, and glass transition temperatures, by measuring the heat absorbed or released during these processes. The equipment operates by comparing the heat flow to the universal compatibilizer (UC) material with a reference sample under identical temperature conditions, ensuring precise measurement of thermal events. The heating process for the universal compatibilizer (UC) material follows a programmed temperature profile, allowing the detection of specific thermal transitions. The differential scanning calorimetry records exothermic and endothermic events, with exothermic peaks corresponding to energy release, such as crystallization, and endothermic peaks indicating energy absorption, such as melting or glass transition. The heat flow curve generated by the differential scanning calorimetry provides detailed insights into the thermal behavior of the universal compatibilizer (UC) material, including the specific temperatures and energy changes associated with each transition. The analysis confirms the thermal stability and phase transformation properties of the universal compatibilizer (UC) material, offering valuable information for its application in environments that require consistent thermal performance and material integrity.

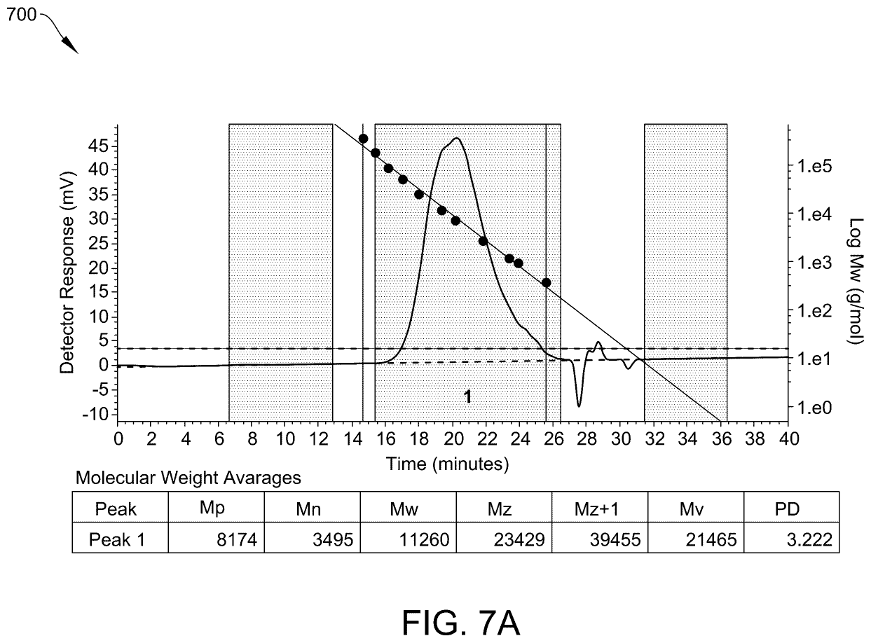

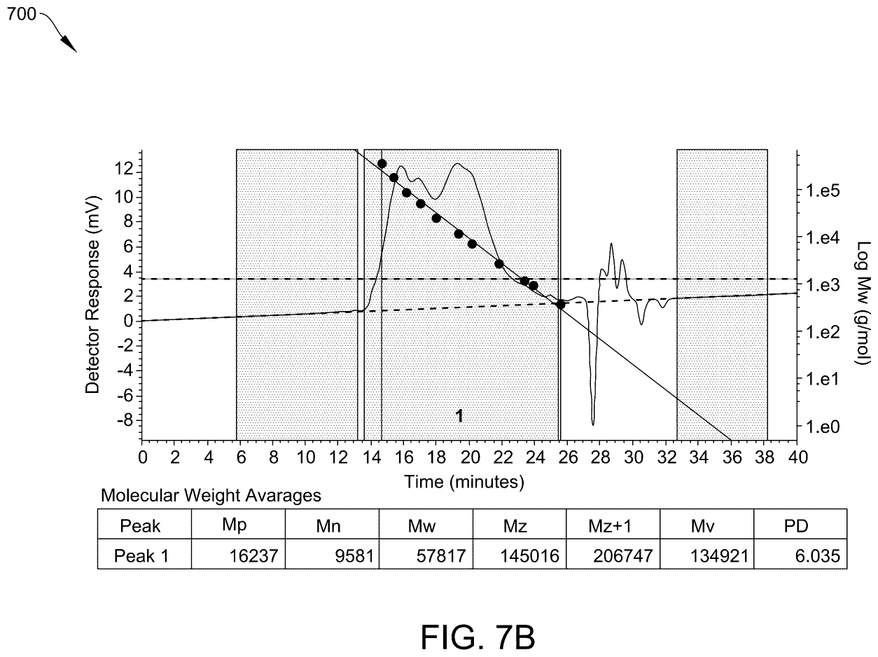

FIGS. 7A and 7B illustrates a GPC characterization of precursor of UC-1.1 and UC-1.1 respectively as examples, in accordance with an embodiment of the present invention.

The Gel Permeation Chromatography (GPC) profiles shown in FIGS. 7A and 7B illustrate the molecular-weight evolution of the compatibilizer as it progresses from its precursor form to the finalized random copolymer. In FIG. 7A, the precursor material exhibits a comparatively lower molecular-weight distribution, characterized by a sharper peak and a narrower dispersity, indicating the presence of shorter polymer chains formed in the early stages of radical polymerization. The calibration of molecular weight using polystyrene standards ensures that the obtained Mn, Mw, and PDI values accurately reflect the intrinsic chain-length characteristics of the precursor prior to segment incorporation. This initial distribution provides a baseline for verifying successful polymer growth during subsequent synthesis steps.

FIG. 7B demonstrates the broadened and shifted molecular-weight profile of the fully developed compatibilizer, showing increased peak intensity toward higher molecular-weight regions. The emergence of a wider elution envelope and higher-average molecular weights confirm the addition of multiple structurally distinct monomer segments into the polymer backbone. This broadened distribution is consistent with the formation of a random copolymer comprising soft aliphatic chains, semi-rigid hydrocarbon segments, hard aromatic structures, and polar reactive units. The GPC results, therefore, provide a molecular “fingerprint” that supports the formation of a multi-segment architecture designed for interaction with a wide range of post-consumer recycled plastics.

The molecular weight characterization of the universal compatibilizer (UC) and its precursor through Gel Permeation Chromatography (GPC) illustrates the detailed information about different types of molecular weight including Peak Molecular Weight (Mp), Number-Average Molecular Weight (Mn) , Weight-Average Molecular Weight (Mw), Z-Average Molecular Weight (Mz), Z+1-Average Molecular Weight (Mz+1), Viscosity-Average Molecular Weight (Mv) and Polydispersity index (PDI). A solution of the random polymer in Tetrahydrofuran (THF) is injected into the GPC system packed with three columns for better separation. The elution time is converted to molecular weight using a calibration curve which is established by polystyrene standards covering the molecular weight (Mw) from 370 to 364,000. By providing key parameters like the Number-Average Molecular Weight (Mn) , Weight-Average Molecular Weight (Mw) and the Polydispersity index (PDI), Gel Permeation Chromatography (GPC) offers a fundamental “fingerprint” of a polymer sample.

The comparative analysis further confirms that the purification and sediment-separation steps effectively isolate the desired random copolymer fraction. The final chromatogram displays a stable, unimodal distribution without excessive low-molecular-weight shoulders. The higher molecular weight and controlled dispersity of the final material contribute to the compatibilizer's mechanical reinforcement performance, thermal stability, and blending reliability during recycling processes such as extrusion and injection molding. Collectively, the GPC data substantiate that the polymerization and purification procedures yield a robust compatibilizer with the molecular characteristics required for efficient integration into mixed post-consumer plastic streams.

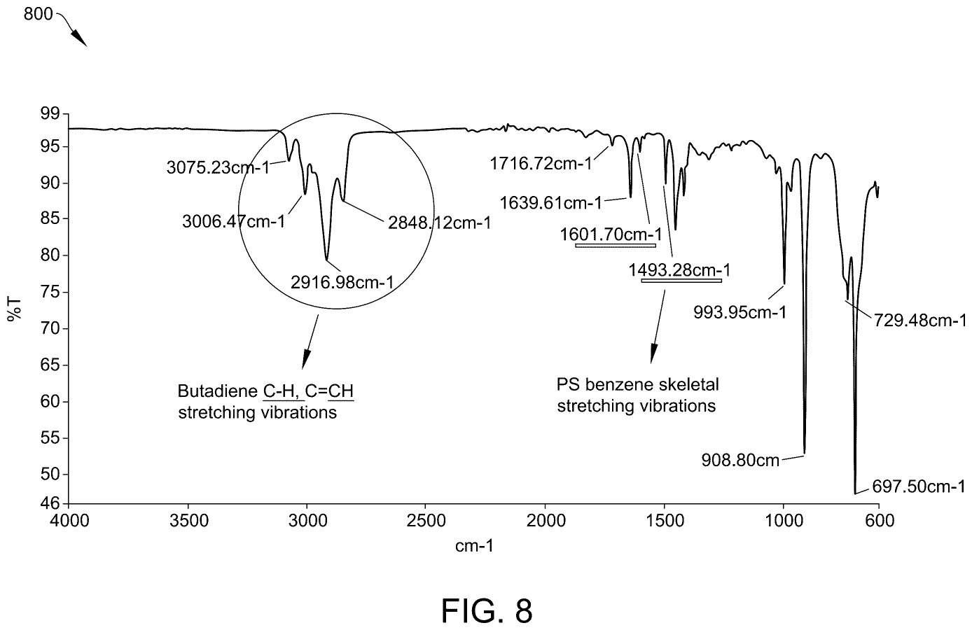

FIG. 8 illustrates a FTIR characterization of UC-1.1, in accordance with an embodiment of the present invention.

The Fourier transform infrared spectroscopy characterization of UC-1 illustrates the absorption spectra of the UC-1 material, which provides detailed information about its molecular structure and chemical bonding. The Fourier transform infrared spectroscopy characterization operates by passing infrared radiation through the UC-1 material and measuring the wavelengths absorbed by the material. The absorption spectrum generated identifies the functional groups present in the UC-1 material based on the characteristic vibration frequencies of specific chemical bonds. The Fourier transform infrared spectroscopy characterization highlights distinct absorption peaks corresponding to stretching, bending, or scissoring vibrations of butadiene and styrene within the UC-1 material. The spectrum also reveals the presence of aromatic, aliphatic, or other structural motifs, confirming the composition and purity of the UC-1 material. The analysis ensures that the UC-1 material maintains the expected chemical structure without impurities or unwanted side reactions. The Fourier transform infrared spectroscopy characterization provides precise identification of functional groups and bond interactions, which are critical for understanding the chemical stability and potential reactivity of the UC-1 material. This information aids in determining the suitability of the UC-1 material for specific applications where chemical compatibility and integrity are essential.

In an exemplary embodiment, the universal compatibilizer-1 (UC-1) is synthesized according to the method of (A)m(B)n(C)p shown in FIG. 5A, based on precursor of copolymer of butadiene with 1,4-addition and 1,2-addition with 1,2-addition terminal alkene as the functional group for further radical polymerization, and the molecular weight characterization of the precursor is demonstrated in FIG. 7A with Mn 3495, Mw 11260 and PDI 3.22. The radical polymerization is conducted at 100° C. for 12 hours using tert-butyl peroxybenzoate as the initiator. UC-1 comprises segment A as 1,3-butadiene (1,4-addition) (30-50 mol %), segment B as 1,3-butadiene (1,2-addition) (30-50 mol %), and segment C as styrene (10-30 mol %). By adjusting the monomer ratio of radical polymerization, the ratio of segment A, B, and C is controlled. Two examples of UC-1.1 (A: 40-45 mol %, B: 40-45 mol %, C: 15-20 mol %) and UC-1.2 (A: 40-45 mol %, B: 30-35 mol %, C: 25-30 mol %) are obtained and characterized. And The structure of the compatibilizer UC-1 may be characterized by FTIR and 1H NMR. For example, as shown in FIG. 8, for UC-1.1, the peaks of 2848 to 3075 cm-1 are correlated to stretching vibrations of —CH═CH2 and —CH═CH— in butadiene, while the peaks of 1601 cm-1 and 1493 cm-1 are correlated to the typical PS benzene skeletal. Thermal properties are studied by TGA and DSC. For example, for UC-1.1, as shown in FIGS. 6A and 6B, the glass transition temperature (T_{g}) is −69° C. and the decomposition temperature (T_{d}) by TGA is 459° C., indicating UC-1 maintain its thermal stability under the processing window of common plastics. And the molecular weight of the compatibilizer copolymer is characterized by GPC as shown in FIG. 7B, and Mn, Mw and PDI of UC-1.1 are 9581, 57817 and 6.04, respectively. While for UC-1.2, the glass transition temperature (T_{g}) and the decomposition temperature (T_{d}) is −74° C. and 432° C., respectively, and Mn, Mw and PDI by GPC of UC-1.2 are 22065, 73356 and 3.33, respectively.

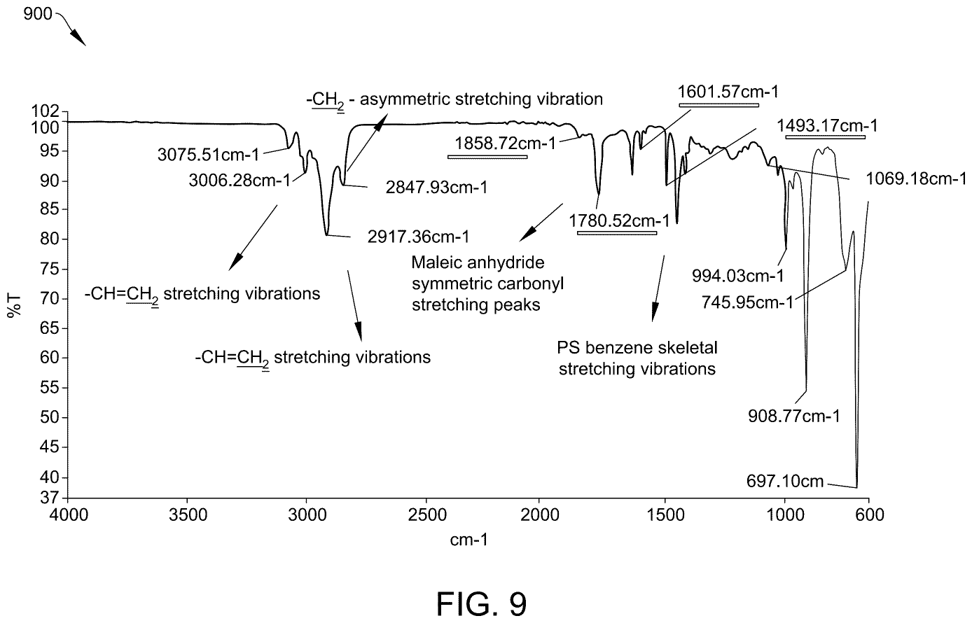

FIG. 9 illustrates a FTIR characterization of UC-2, in accordance with an embodiment of the present invention.

The Fourier transform infrared spectroscopy characterization of UC-2 illustrates the absorption spectra that provides detailed insights into the molecular structure and chemical bonding of the UC-2 material. The Fourier transform infrared spectroscopy characterization involves the passage of infrared radiation through the UC-2 material and the measurement of absorbed wavelengths to identify specific functional groups. The resulting spectrum displays absorption peaks that correspond to the vibrational modes of chemical bonds such as stretching, bending, or scissoring associated with C—H, C═C, or C═O bonds within the UC-2 material. These peaks confirm the presence of specific chemical functionalities and structural motifs, such as aromatic, aliphatic, or other molecular arrangements. The analysis ensures that the UC-2 material aligns with the expected chemical composition and is free from impurities or undesired byproducts. The Fourier transform infrared spectroscopy characterization also verifies the interactions between molecular components and identifies bonding characteristics critical for the stability and performance of the UC-2 material. The information gained through this characterization plays a crucial role in evaluating the compatibility, chemical integrity, and potential applications of the UC-2 material, ensuring its suitability for intended uses and confirming its structural fidelity.

In an exemplary embodiment, the universal compatibilizer-2 (UC-2) is synthesized according to the method of (A)m(B)n(C)p(D)q shown in FIG. 5A, based on precursor of copolymer of butadiene with 1,4-addition and 1,2-addition with 1,2-addition terminal alkene as the functional group for further radical polymerization, and the molecular weight characterization of the precursor is demonstrated in FIG. 7A with Mn 3495, Mw 11260 and PDI 3.22. The first radical polymerization is conducted at 100° C. for 12 hours using tert-butyl peroxybenzoate as the initiator, and the second radical polymerization is conducted at 100° C. for 2 hours using tert-butyl peroxybenzoate as the initiator. UC-2 comprises segment A as1,3-butadiene (1,4-addition) (30-50 mol %), segment B as 1,3-butadiene (1,2-addition), (10-30 mol %), segment C as styrene (10-30 mol %), and segment D as maleic anhydride and acrylic acid (5-25 mol %, maleic anhydride: acrylic acid=5:1). Two examples of UC-2.1 (A: 40-45 mol %, B: 15-25 mol %, C: 15-20 mol %, D: 20-25 mol %) and UC-2.2 (A: 40-45 mol %, B: 20-30 mol %, C: 25-30 mol %, D: 5-10 mol %) are obtained and characterized. The structure of the compatibilizer UC-2 is characterized by FTIR and 1H NMR. As shown in FIG. 9, UC-2.1 as an example, the peaks of 2847 to 3075 cm-1 may be correlated to stretching vibrations of —CH═CH2 and —CH═CH— in butadiene, while the peaks of 1601 cm-1 and 1493 cm-1 may be correlated to the typical PS benzene skeletal, while the peaks of 1858 and 1780 cm-1 may be correlated to carbonyl C═O stretching of maleic anhydride and acrylic acid. Thermal properties are studied by TGA and DSC. For UC-2.1, the glass transition temperature (T_{g}) of is −69° C. and the decomposition temperature (T_{d}) by TGA is 423° C., indicating UC-2 may maintain its thermal stability under the processing window of common plastics. And the molecular weight of the compatibilizer copolymer may be characterized by GPC, and Mn, Mw and PDI of UC-2.1 are 23028, 79749 and 3.46, respectively. While for UC-2.2, the glass transition temperature (T_{g}) and the decomposition temperature (T_{d}) is −73° C. and 427° C., respectively, and Mn, Mw and PDI by GPC of UC-2.2 are 24935, 101547 and 4.07, respectively.

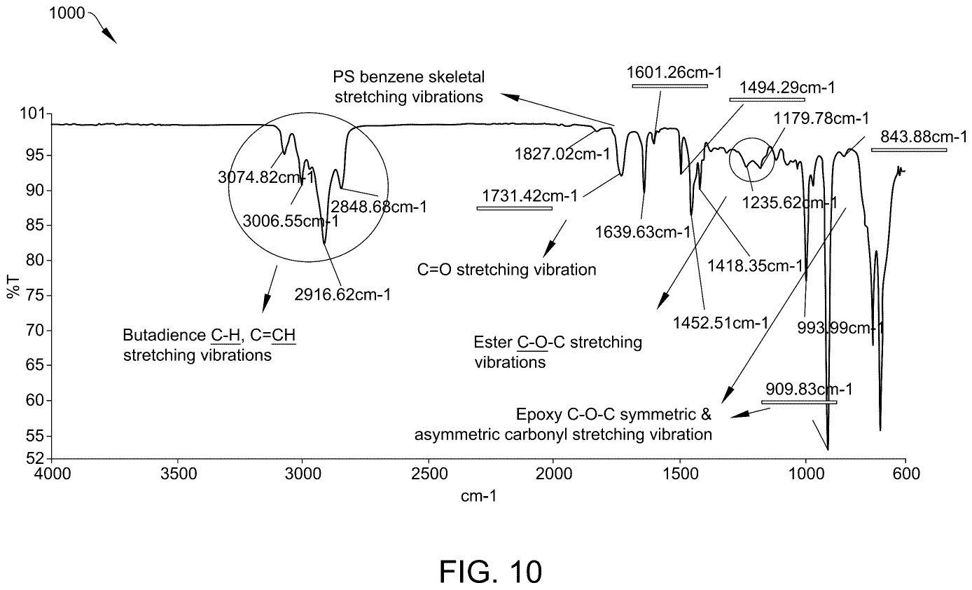

FIG. 10 illustrates a FTIR characterization of UC-3, in accordance with an embodiment of the present invention.

The Fourier transform infrared spectroscopy characterization of UC-3 illustrates the absorption spectra that provides detailed insights into the molecular structure and chemical bonding of the UC-3 material. The Fourier transform infrared spectroscopy characterization involves the passage of infrared radiation through the UC-3 material and the measurement of absorbed wavelengths to identify specific functional groups. The resulting spectrum displays absorption peaks that correspond to the vibrational modes of chemical bonds such as stretching, bending, or scissoring associated with C—H, C═C, C—O—C, or C═O bonds within the UC-3 material. These peaks confirm the presence of specific chemical functionalities and structural motifs, such as aromatic, aliphatic, or other molecular arrangements. The analysis ensures that the UC-3 material aligns with the expected chemical composition and is free from impurities or undesired byproducts. The Fourier transform infrared spectroscopy characterization also verifies the interactions between molecular components and identifies bonding characteristics critical for the stability and performance of the UC-3 material. The information gained through this characterization plays a crucial role in evaluating the compatibility, chemical integrity, and potential applications of the UC-3 material, ensuring its suitability for intended uses and confirming its structural fidelity.

In an exemplary embodiment, the universal compatibilizer-3 (UC-3) is synthesized according to the method of (A)m(B)n(C)p(D)q shown in FIG. 5B, based on precursor of copolymer of butadiene with 1,4-addition and 1,2-addition, and with terminal alkene as the functional group for further radical polymerization, and the molecular weight characterization of the precursor is demonstrated in FIG. 7A with Mn 3495, Mw 11260 and PDI 3.22. The radical polymerization is conducted at 100° C. for 12 hours using tert-butyl peroxybenzoate as the initiator. UC-3 comprises segment A as 1,3-butadiene (1,4-addition) (30-50 mol %), segment B as 1,3-butadiene (1,2-addition), (10-30 mol %), segment C as styrene (10-30 mol %), and segment D as glycidyl methacrylate, 2-acetoxyethyl methacrylate (5-25 mol %, glycidyl methacrylate: 2- acetoxyethyl methacrylate=1:1). The structure of the compatibilizer UC-3 is characterized by FTIR and 1H NMR. As shown in FIG. 10, for UC-3, the benzene skeletal stretching vibrations of PS hard sector are clear at 1494 and 1601 cm-1, and the intensities of epoxy symmetric and asymmetric stretching vibrations are also strong at 844 and 910 cm-1. The typical twin shoulder peaks at 1180 and 1236 cm-1 marked in red cycle represent the ester stretching vibrations. Thermal properties are studied by TGA and DSC. For UC-3, the glass transition temperature (T_{g}) of is −66° C. and the decomposition temperature (T_{d}) by TGA is 421° C., indicating UC-3 may maintain its thermal stability under the processing window of common plastics. And the molecular weight of the compatibilizer copolymer may be characterized by GPC, and Mn, Mw and PDI of UC-3 are 4378, 21823 and 4.98, respectively.

FIG. 11 illustrates a FTIR characterization of UC-4, in accordance with an embodiment of the present invention.

The Fourier transform infrared spectroscopy characterization of UC-4 illustrates the absorption spectra that provides detailed insights into the molecular structure and chemical bonding of the UC-4 material. The Fourier transform infrared spectroscopy characterization involves the passage of infrared radiation through the UC-4 material and the measurement of absorbed wavelengths to identify specific functional groups. The resulting spectrum displays absorption peaks that correspond to the vibrational modes of chemical bonds such as stretching, bending, or scissoring associated with C—H (alkene), C—H (alkane), C═C, or C═O bonds within the UC-4 material. These peaks confirm the presence of specific chemical functionalities and structural motifs, such as aromatic, aliphatic, or other molecular arrangements. The analysis ensures that the UC-4 material aligns with the expected chemical composition and is free from impurities or undesired byproducts. The Fourier transform infrared spectroscopy characterization also verifies the interactions between molecular components and identifies bonding characteristics critical for the stability and performance of the UC-4 material. The information gained through this characterization plays a crucial role in evaluating the compatibility, chemical integrity, and potential applications of the UC-4 material, ensuring its suitability for intended uses and confirming its structural fidelity.

In an exemplary embodiment, the universal compatibilizer-4 (UC-4) is synthesized by direct radical polymerization of all monomers, without precursors. The radical polymerization is conducted at 55° C. for 12 hours using azobisisobutyronitrile as the initiator. UC-4 comprises segment A as the long alkyl chain in acrylate, n-octyl acrylate (15-20 mol %), segment B as polymerization main chain of double bond (C2) of n-octyl acrylate (15-20 mol %), segment C as styrene (40-45 mol %), and D as maleic anhydride and acrylic acid (20-25 mol %, maleic anhydride: acrylic acid=1:2). The structure of the compatibilizer UC-4 is characterized by FTIR and 1H NMR. As shown in FIG. 11, for UC-4, The maleic anhydride symmetric carbonyl stretching peaks at 1773 and 1854 cm-1 had strong intensity, and a sharp peak at 1454 cm-1 also indicated the implementation of n-octyl acrylate. Thermal properties are studied by TGA and DSC. For UC-4, the glass transition temperature (T_{g}) of is 174° C. and the decomposition temperature (T_{d}) by TGA is 345° C., indicating UC-2 may maintain its thermal stability under the processing window of common plastics. And the molecular weight of the compatibilizer copolymer may be characterized by GPC, and Mn, Mw and PDI of UC-4 are 43520, 70292 and 1.61, respectively.

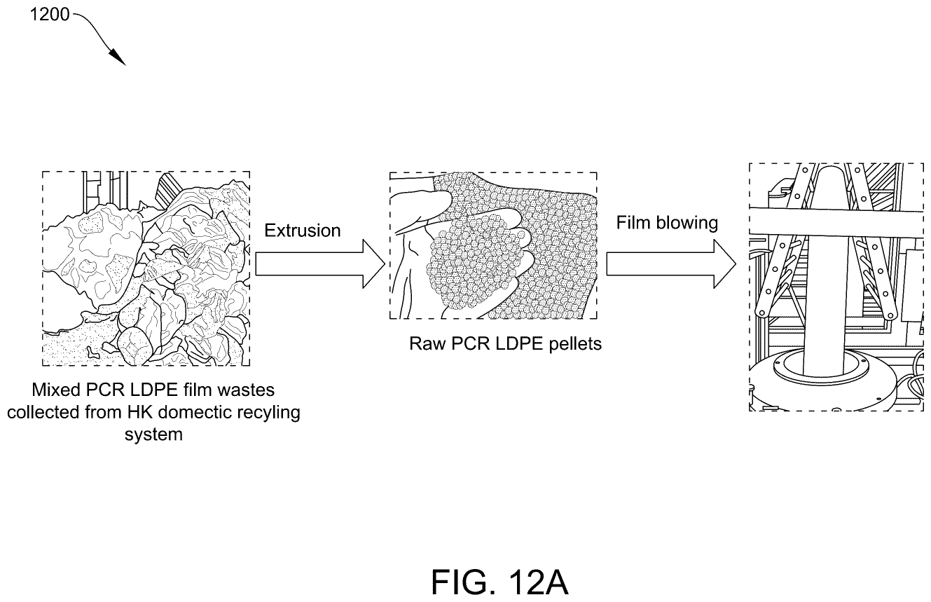

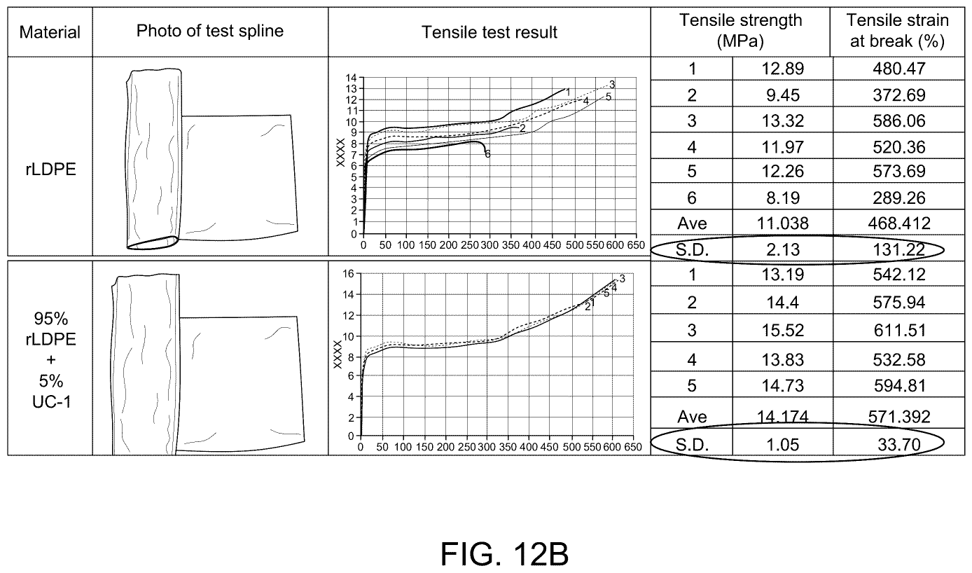

FIGS. 12A and 12B illustrates a process of recycling of mixed PCR LDPE film waste, and an evaluation of UC-1.1 in upcycling of PCR LDPE for film blowing, in accordance with an embodiment of the present invention.

In an exemplary embodiment, the evaluation of UC-1.1 in upcycling post-consumer recycled low-density polyethylene film wastes for film blowing demonstrates the material's effectiveness in enhancing mechanical properties. The analysis involves blending 95 weight percent post-consumer recycled low-density polyethylene with 5 weight percent UC-1.1 in film blowing process and assessing the resulting composite for tensile strength and tensile strain at break of the film according to ASTM D882, with all film samples for comparison are from machine direction (MD) with thickness 0.04-0.05mm. The photographic representation of the test spline highlights the integrity and uniformity of the film, confirming its suitability for tensile testing. The tensile strength results in megapascals exhibit an average value of 11.038 with a standard deviation of 2.13 for the post-consumer recycled low-density polyethylene material, while the blend with UC-1.1 achieves an improved average tensile strength of 14.174 with a standard deviation of 1.05. The increase in tensile strength demonstrates the ability of UC-1.1 to enhance the load-bearing capacity of the recycled material. The tensile strain at break, expressed as a percentage, further supports this enhancement, showing an average value of 468.412 with a standard deviation of 131.22 for the post-consumer recycled low-density polyethylene material and a significantly higher average value of 571.392 with a standard deviation of 33.70 for the blend. The evaluation may confirm that the UC-1.1 effectively upcycles post-consumer recycled low-density polyethylene, providing improved mechanical performance for film-blowing applications.

In an exemplary embodiment, the polyolefins such as LDPE are hydrocarbon polymers which may be relatively stable during recycling, and the major issue of this type of plastic is the contamination induced incompatibility, leading to unstable processability and properties variation according to the feedback from industry. Especially for film wastes, since there may be various PE type plastic products in the market, they may be HDPE, common LDPE and another type of linear LDPE (LLDPE), also, PP may also be one of the film form products in the market, and even PET may be in the form of films in the market, and in the actual recycling system, it's impossible to completely separate those plastics, especially for film/bag type wastes, which are light in weight and bulky in volume, therefore they may be difficult to be collected, sorting, washing and recycled, in most cases, especially in ma be HK, the domestic film/bag wastes are ended up in landfill.

As illustrated in FIG. 12, post-consumer recycled polyethylene pellets are obtained from domestic film and bag wastes sourced from the market without sorting. Films and bags commonly consist of mainly low-density polyethylene or linear low-density polyethylene in many instances. However, some are composed of high-density polyethylene, polypropylene, or include fillers such as calcium carbonate, or even minor polyethylene terephthalate, making them challenging to sort and recycle within conventional recycling systems.

The universal compatibilizer UC-1.1 is incorporated into post-consumer recycled polyethylene during the film blowing process to evaluate its compatibilization performance. The inclusion of the universal compatibilizer UC-1.1 enhances processing stability during the film blowing process, which is otherwise unstable in the absence of a compatibilizer. Samples containing 5 wt % of the universal compatibilizer UC-1.1 exhibit more uniform and stable performance compared to control samples processed under identical conditions.

The universal compatibilizer UC-1.1 significantly reduces the deviation of tensile strength in the blown film from 2.13 to 1.05 and decreases the deviation in elongation at break from 131.22 to 33.70. Moreover, both tensile strength and elongation at break of the films demonstrate noticeable improvement. These results validate the effectiveness of the universal compatibilizer UC-1.1 in upcycling film and bag wastes, enhancing process stability, improving mechanical properties, and minimizing property deviation in post-consumer recycled polyethylene films.

In an exemplary embodiment, UC-2.1 is also evaluated in the above recycling of PE film wastes. Nevertheless, the general universal compatibilizer (A)ₙ(B)ₘ(C)ₚ(D)_{q}, such as UC-2.1, may be expected to be also applicable in the above example, also providing better compatibility compared to without any compatibilizers. The analysis involves blending 95 weight percent post-consumer recycled low-density polyethylene with 5 weight percent UC-2.1 in film blowing process and assessing the resulting composite for tensile strength and tensile strain at break of the film according to ASTM D882, with all film samples for comparison are from machine direction (MD) with thickness 0.04-0.05 mm. UC-2.1 enhances the stability of the film-blowing process, reducing deviations in tensile strength from 2.13 MPa to 1.39 MPa and reducing deviations in elongation at break from 131.22% to 44.40%. Additionally, the overall tensile strength improves, reaching an average value of 14.79 MPa, while the elongation at break achieves an average of 582.82%, slightly better than that with UC-1.1, and much better than that without any compatibilizer, underscoring its ability to homogenize and stabilize the recycled plastic composition.

In the plastic industry, blending post-consumer recycled (PCR) plastic with the corresponding virgin plastic is the most common way to utilize PCR plastics. Increasing the recycled content of plastic products is the global trend to enhance the sustainability of plastic industry.

In an exemplary embodiment, UC-2.1 is also evaluated in the compounding of the above PCR LDPE pellet with virgin LDPE. As a control sample for comparison, 50 wt % of PCR PE pellet is mixed with 50 wt % virgin LDPE pellet and then subjected to film blowing process to obtain film for testing according to ASTM D882, with all film samples for comparison are from machine direction (MD) with thickness 0.04-0.05 mm. The tensile strength is 18.2 MPa, while the elongation at break is 548.9%. In an exemplary embodiment, 1 wt % of UC-2.1 is mixed with 50% PCR PE pellet and 49% virgin LDPE pellet and then subjected to film blowing process to obtain film for testing according to ASTM D882, with all film samples for comparison are from machine direction (MD) with thickness 0.04-0.05 mm. The film obtained achieved better quality with tensile strength 23.6 MPa, and elongation at break 593%, demonstrating the performance of compatibilizer UC-2.1 in improving the quality of the recycled plastics.

In an exemplary embodiment, UC-2.1 is also evaluated in the recycling of post-consumer recycled (PCR) expand polystyrene (EPS) foam boxes, which are collected from domestic recycling system, wherein the recycled EPS foam boxes are contaminated with different types of adhesive tapes, potentially contaminated with minor amounts of PP, PE, PVC. Brittleness (low impact strength) is known as the major issue of the PCR PS from foam waste. As a control sample for comparison, the raw PCR PS pellet is obtained from extrusion of recycled EPS foam box wastes, and the PCR PS pellet is then subjected to injection molding to prepare testing specimens for the notched impact strength test according to ASTM D256. The raw PCR PS comprises a low notched impact strength of 2.1 kJ/m², which is too brittle for further application. Industry commonly uses virgin HIPS and SBS rubber to blend with PCR PS to utilize PCR PS with the blended composite having a better impact strength. As another control sample for comparison, 50 wt % of the above PCR PS is blended with 45 wt % of virgin HIPS and 5 wt % of SBS rubber by extrusion and followed by injection molding to prepare testing specimens for the notched impact strength test according to ASTM D256, and the notched impact strength for the obtained HIPS with 50% PCR PS is 6.8 kJ/m². As the PCR PS contains minor amount of different types of tape materials, in an exemplary embodiment, 1 wt % of UC-2.1 is mixed with 50% PCR PS and 44% virgin HIPS and 5% SBS rubber by extrusion and followed by injection molding to prepare testing specimens for the notched impact strength test according to ASTM D256, and the notched impact strength for the obtained HIPS with 50% PCR PS is further improved to 7.4 kJ/m², demonstrating the performance of compatibilizer UC-2.1 in improving the quality of the recycled plastics.

In an exemplary embodiment, UC-2.2 is also evaluated in the above recycling of PCR EPS foam box waste. UC-2.2 comprises a higher ratio of segment C, that is higher ratio of styrene segment, compared with UC-2.1, providing hardness in the structure. In the previous example using UC-2.1, the notched impact strength is improved obviously with only 1 wt % of UC-2.1, while the hardness in flexural module according to ASTM D790 is slightly decreased from 2310 MPa to 2210 MPa, about 4% less, which although does not affect much in the properties. Similar to the above case, 1 wt % of UC-2.2 is mixed with 50% PCR PS and 44% virgin HIPS and 5% SBS rubber by extrusion and followed by injection molding to prepare testing specimens for the notched impact strength test according to ASTM D256 and flexural module according to ASTM D790, the impact strength is improved to 7.2 kJ/m² similar to UC-2.1, while the flexural module slightly improved to 2280 MPa, with less decreasing of flexural module which may be benefit from the higher hard segment ratio of UC-2.2, demonstrating that the ratio of different segments are optimized to have compatibilization performance and slightly adjust the properties.

While UC-2 shows its compatibilization performance in different plastic recycling systems, different designs of the compatibilizers such as UC-3 and UC-4 for example, may be optimized for different PCR plastic systems. For example, UC-3 contains glycidyl groups which are known to be able to react with polyester such as PET, therefore, it may potentially work better with PCR plastics mixed with significant amount of PET. For example, UC-4 contains high ratio of styrene segment and carbonyl group, which may potentially work better with PCR plastics mixed with significant amount of polycarbonate (PC).

The disclosed invention enhances compatibility of different copolymers by reducing the interfacial tension between immiscible polymers, enabling better dispersion and adhesion. This leads to improved homogeneity during recycling. The disclosed invention comprises improved mechanical properties such as, higher tensile strength, impact resistance, and elongation. This makes the disclosed invention more suitable for a wide range of applications.

The disclosed invention comprises improved thermal stability with high-temperature processing capability, reduced degradation and enhanced product quality. In addition, the disclosed invention is more cost-effective and contributes to lowering the carbon footprint of plastic products. The disclosed invention may find applications in production of packaging materials, automotive components, construction materials, consumer goods, 3D printing, and more.

In a case that no conflict occurs, the embodiments in the present disclosure and the features in the embodiments may be mutually combined. The foregoing descriptions are merely specific implementations of the present disclosure but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A formulation for compatibilizing post-consumer recycled plastics, the formulation comprising:
a random copolymer represented by the structural formula (A)n(B)m(C)p(D)q,
wherein n, m, p, and q are independently no less than 1,
wherein A, B, C, and D, are structurally different and arranged in a random sequence;
wherein the formulation ensures universal compatibility with a plurality of recycled plastic, reduces quality variations, enhances process stability, and improves mechanical properties, requiring a dosage of a pre-determined amount for efficient and sustainable recycling applications; and
wherein the plurality of recycled plastic is post-consumer recycled plastics.

2. The formulation of claim 1, wherein the formulation comprises a plurality of additives, a plurality of fillers and a combination thereof.

3. The formulation of claim 1, wherein the random copolymers comprises:
a soft and non-polar segment A, in a pre-determined amount, to enhance compatibility with low-density polyethylene (LDPE) and linear low-density polyethylene (LLDPE);
a segment B with middle rigidity, in a pre-determined amount, to provide structural adaptation to high-density polyethylene (HDPE) and polypropylene (PP);
a hard segment C, in a pre-determined amount, to reinforce compatibility with rigid plastics, including polystyrene (PS), polycarbonate (PC), and polyethylene terephthalate (PET); and
a polar and reactive segment D, in a pre-determined amount, to improve compatibility with polar plastics such as polyethylene terephthalate (PET), polycarbonate (PC), and inorganic fillers, including calcium carbonate (CaCO₃).

4. The formulation of claim 1, wherein the soft and 3 non-polar segment A in the random copolymer comprises hydrocarbon chains with main chain lengths from C4-C10, selected from butadiene, isoprene, pentene, hexene, octene, decene, hexyl acrylate, and octyl acrylate.

5. The formulation of claim 1, wherein the segment B with middle rigidity in the random copolymer includes hydrocarbon chains with main chain lengths from C2-C4, selected from ethylene, propylene, butadiene, or isoprene.

6. The formulation of claim 1, wherein the hard segment C in the random copolymer includes aromatic groups selected from styrene, vinyl naphthalene, and norbornene,.

7. The formulation of claim 1, wherein the polar and reactive segment D in the random copolymer includes polar reactive groups selected from maleic anhydride, methyl acrylate, glycidyl methacrylate, 2-acetoxyethyl methacrylate, and acrylic acid.

8. The formulation of claim 1, wherein the simplified versions of the random copolymer compatibilizer are selected from (A)n(B)m(C)p, (A)n(B)m(D)q, and (A)n(C)p(D)q for applications involving less contaminated post-consumer recycled plastics.

9. The formulation of claim 1, wherein the random copolymer exhibits thermal stability with a glass transition temperature (Tg) of no more than 180° C. and a decomposition temperature (Td) of no less than 300° C.

10. The formulation of claim 1, wherein the random copolymer comprises a molecular weight of Mn no less than 4000 Da, Mw no less than 25,000.

11. The formulation of claim 1, wherein the soft and non-polar segment A of the random copolymer is present in an amount of 10-50 mol %, based on the random copolymer and the segment B with middle rigidity is present in an amount of 10-50 mol % based on the random copolymer.

12. The formulation of claim 1, wherein the hard segment C of the random copolymer is present in an amount of 5-50 mol % based on the random copolymer and the polar and reactive segment D is present in an amount of 5-50 mol % based on the random copolymer.

13. The formulation of claim 1, wherein the dosage of the random copolymer compatibilizer is 0.5-10% by weight, preferably 1-5% by weight.

14. A method for compatibilizing post-consumer recycled plastics, the method comprising:
synthesizing a random copolymer represented by the structural formula (A)n(B)m(C)p(D)q,
wherein n, m, p, and q are independently no less than 1, the random copolymer comprises a soft and non-polar segment A in a pre-determined amount, a segment B with middle rigidity in a pre-determined amount, a hard segment C in a pre-determined amount, and a polar and reactive segment D in a pre-determined amount;
wherein the synthesis includes radical polymerization followed by sediment separation in a solvent to isolate the desired random copolymer;
preheating the post-consumer recycled plastics to remove residual moisture and facilitate uniform mixing during blending;
blending the synthesized random copolymer with post-consumer recycled plastics containing mixed polymer types and incorporating a plurality of functional additives, such as impact modifier, antioxidants and stabilizers;
processing the blended mixture through a plurality of recycling process and a plurality of recycling and plastic processes selected from extrusion, film blowing, and injection molding; and
adjusting processing parameters, including temperature and shear rate, to align with the thermal stability of the recycled plastics and the random copolymer and ensure compatibility during recycling.

15. The method of claim 14, wherein the preparation of random copolymer includes but not limited to radical polymerization of a precursor material and direct radical polymerization of corresponding monomers for segment A, B, C and D.

16. The method of claim 14, wherein the precursor material for the preparation of the random copolymer comprises a molecular weight of Mn no more than 3,500 Da, and Mw no more than 15,000.

17. The method of claim 14, wherein the whole preparation process of random copolymer is performed under normal pressure, without the requirement of high pressure.

18. The method of claim 14, wherein the reaction temperature of the radical polymerization is ranging from 50-100 ° C. and reaction time is ranging from 5-20 hours based on the reactivity of the monomers and the desired degree of polymerization.

19. The method of claim 14, wherein the purification and isolation of the random copolymer includes re-applying the random copolymer in the solvent to perform sediment separation, the solvent used is different from the solvent used in the reaction mixture, and random copolymer product exhibits limited solubility in the solvent for sediment separation.

20. The method of claim 14, wherein the solvent for sediment separation is selected from toluene, benzene, chlorobenzene, tetrahydrofuran, hexane, chloroform, diisopropyl ether, isopropanol, tert-butanol, acetone and any combination thereof.
